(19) United States
(12) Patent Application Publication
(10) Pub. No.: US 2021/0347489 A1
(43) Pub. Date: Nov. 11, 2021

(54) Systems and Methods for Facilitating Climate Control for Aerial Vehicles

(71) Applicant: Joby Elevate, Inc., Santa Cruz, CA (US)

(72) Inventors: Brian Francis Learn, Oakland, CA (US); Luke Asher Wilhelm, Sausalito, CA (US); Hervé Martins-Rivas, Mountain View, CA (US)

(21) Appl. No.: 17/314,680

(22) Filed: May 7, 2021

Related U.S. Application Data
(60) Provisional application No. 63/021,392, filed on May 7, 2020.

(51) Int. Cl. B64D 13/06; B64D 33/08

(52) U.S. Cl. CPC B64D 13/06; B64D 2013/0655; B64D 2013/0614; B64D 33/08

(57) ABSTRACT

Systems and methods for facilitating climate control for aerial vehicles are provided. A system includes a climate control infrastructure with devices configured to facilitate climate control operations for aircraft at an aerial facility. The system obtains data associated with a multi-modal transportation service, and aerial vehicles and facilities for providing the service. The vehicle data can include thermal parameters associated with an aerial vehicle that indicate a temperature for aerial components such as a power source, a cabin, or hardware components within the cabin. The system can determine a climate control configuration for a climate control infrastructure of an aerial facility at which the aerial vehicle is located based on the obtained data. The climate control configuration can identify a desired temperature for a component of the aerial vehicle. The system can generate and communicate command signals for controlling the climate control infrastructure to implement the climate control configuration.

### RELATED APPLICATIONS

This application claims priority to and the benefit of U.S. Provisional Patent Application No. 63/021,392, filed May 7, 2020, which is hereby incorporated by reference in its entirety.

### FIELD

The present disclosure relates generally to the aircraft climate control. More particularly, the present disclosure relates to systems and methods for coordinating improved offboard climate control operations for aerial vehicles.

### BACKGROUND

A wide variety of modes of transport are available within cities. For example, people can walk, ride a bike, drive a car, take public transit, or use a ride sharing service. As population densities and demand for land increase, however, many cities are experiencing problems with traffic congestion and the associated pollution. Consequently, there is a need to expand the available modes of transport in ways that can reduce the amount of traffic without requiring the use of large amounts of land.

Air travel within cities can reduce travel time over purely ground-based approaches and alleviate problems associated with traffic congestion.

Vertical takeoff and landing (VTOL) aircraft provide opportunities to incorporate aerial transportation into transport networks for cities and metropolitan areas. VTOL aircraft require much less space to take-off and land than other types of aircraft, making them more suitable for densely populated urban environments. Landing, charging, storing, transferring, and facilitating climate control for VTOL aircraft, however, still presents a variety of challenges.

### SUMMARY

Aspects and advantages of embodiments of the present disclosure will be set forth in part in the following description, or can be learned from the description, or can be learned through practice of the embodiments.

Aspects of the present disclosure are directed to a system for aerial vehicle climate control. The system can include one or more processors and one or more non-transitory computer-readable media that collectively store instructions that, when executed by the one or more processors, cause the system to perform operations. The operations can include obtaining data associated with a multi-modal transportation service. The data associated with the multi-modal transportation service can include itinerary data indicative of one or more flight itineraries for one or more aerial vehicles. The operations can include obtaining vehicle data associated with the one or more aerial vehicles. The vehicle data can be indicative of one or more thermal parameters of the one or more aerial vehicles. The operations can include obtaining facility data associated with an aerial transport facility for providing the multi-modal transportation service. The facility data can be indicative of a climate control infrastructure at the aerial transport facility. The one or more of the aerial vehicles can utilize the aerial transport facility. The operations can include determining a climate control configuration for the climate control infrastructure at the aerial transport facility for a first aerial vehicle based at least in part on the data associated with the multi-modal transportation service, one or more thermal parameters of the first aerial vehicle, and the facility data associated with the aerial transport facility. The operations can include communicating one or more command signals associated with controlling the climate control infrastructure at the aerial transport facility. The command signals can be indicative of the climate control configuration.

Another aspect of the present disclosure is directed to a computer-implemented method for aerial vehicle climate control. The method can include obtaining data associated with a multi-modal transportation service. The data associated with the multi-modal transportation service can include itinerary data indicative of one or more itineraries of one or more aerial vehicles for facilitating one or more multi-modal transportation services. The method can include obtaining vehicle data associated with the one or more aerial vehicles. The vehicle data can be indicative of one or more thermal parameters of the one or more aerial vehicles. The method can include obtaining facility data associated with an aerial transport facility for providing the multi-modal transportation service. The facility data can be indicative of a climate control infrastructure at the aerial transport facility. At least one of the one or more aerial vehicles are to utilize the aerial transport facility. The method can include determining a climate control configuration for the climate control infrastructure at the aerial transport facility for a first aerial vehicle based at least in part on the data associated with the multi-modal transportation service, one or more thermal parameters of the first aerial vehicle, and the facility data associated with the aerial transport facility. The method can include communicating one or more command signals associated with controlling the climate control infrastructure at the aerial transport facility. The command signals are indicative of the climate control configuration.

Another aspect of the present disclosure is directed to another system for aerial vehicle climate control. The system can include a climate control infrastructure, one or more processors, and one or more memory resources storing instructions that, when executed by the one or more processors, cause the system to perform operations. The operations include obtaining data associated with a multi-modal transportation service. The data associated with the multi-modal transportation service includes itinerary data indicative of one or more itineraries of one or more aerial vehicles for facilitating one or more multi-modal transportation services. The operations include obtaining vehicle data associated with the one or more aerial vehicles. The vehicle data can be indicative of one or more thermal parameters of the one or more aerial vehicles. The operations can include obtaining facility data associated with an aerial transport facility for providing the multi-modal transportation service. The facility data can be indicative of the climate control infrastructure and the one or more of the aerial vehicles can utilize the aerial transport facility. The operations can include determining a climate control configuration for the climate control infrastructure at the aerial transport facility for a first aerial vehicle based at least in part on the data associated with the multi-modal transportation service, one or more thermal parameters of the first aerial vehicle, and the facility data associated with the aerial transport facility. The operations can include communicating one or more command signals associated with controlling the climate control infrastructure at the aerial transport facility to the climate control infrastructure. The command signals can be indicative of the climate control configuration.

Other aspects of the present disclosure are directed to various systems, apparatuses, non-transitory computer-readable media, user interfaces, and electronic devices. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

In some cases, the aspects of the present disclosure can utilize autonomous vehicle technology. The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, autonomous vehicles of the present disclosure may reduce traffic congestion in communities as well as provide alternate forms of transportation that may provide environmental benefits.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system according to example implementations of the present disclosure;

FIG. 2 depicts a perspective view of one embodiment of an aerial transport facility according to example implementations of the present disclosure;

FIG. 3 depicts an example landing area according to example implementations of the present disclosure;

FIG. 4 depicts example climate control devices according to example implementations of the present disclosure;

FIG. 5 depicts an example an example landing area with climate control devices according to example implementations of the present disclosure;

FIG. 6 depicts an example data flow diagram for determining a climate control configuration according to example implementations of the present disclosure;

FIG. 7 depicts a flowchart of a method for determining a climate control configuration according to aspects of the present disclosure;

FIG. 8 is a flowchart of a method for determining a climate control configuration according to aspects of the present disclosure; and

FIG. 9 depicts a block diagram of an example computing system according to example embodiments of the present disclosure.

### DETAILED DESCRIPTION

Aspects of the present disclosure are directed to improved systems and methods for coordinating climate control for aerial vehicles. In particular, aspects of the present disclosure are directed to the coordination of a climate control infrastructure at an aerial transport facility. For instance, a service entity can manage and coordinate a plurality of different types of vehicles to provide services to a plurality of users via a transportation platform. By way of example, a user may generate a service request for transportation from an origin location to a destination location via an application running on the user's device. An operations computing system associated with the service entity (e.g., a cloud-based operations computing system, etc.) can obtain data indicative of the service request and generate one or more itineraries (e.g., user itinerary, flight itinerary, etc.) to facilitate transporting the user from the origin location to the destination location. A user itinerary, for example, can be a multi-modal transportation itinerary that includes at least two types of transportation such as, for example, a ground-based vehicle transportation and an aerial transportation. For example, the itinerary can include three legs: a first leg that includes a ground-based vehicle transporting a user from the origin location (e.g., a home, etc.) to a first aerial transport facility; a second leg (e.g., an aerial portion) that includes an aircraft transporting the user from the first aerial transport facility to a second aerial transport facility; and a third leg that includes another ground-based vehicle transporting the user from the second aerial transport facility to the destination location (e.g., a conference center).

The aerial transport facilities can include a plurality of aircraft that are arriving and departing at various times for a variety of different users. To accommodate the plurality of aircraft, each facility can include a landing area with one or more zones (e.g., landing pads, parking locations, charging locations, cooling locations, travel ways, passenger walkways, aircraft maintenance areas, etc.). For instance, aircraft can land and/or take-off from a respective landing pad, park, charge, and/or cool at a respective parking location, etc. The plurality of aircraft can retain heat over time, for example, from the environment (e.g., outside temperatures, etc.) and/or from operation (e.g., heat generated by operating a power source (e.g., batteries, engines, etc.) of the aircraft). Aerial transport facilities of the present disclosure can counteract the retention of heat by utilizing a climate control infrastructure to configured to cool one or more components (e.g., the interior of a cabin, hardware within the cabin, a power source, etc.) of an aerial vehicle. To do so, the climate control infrastructure can include a cooling system and/or a plurality of cooling devices configured to interface with one or more components of the aerial vehicle to facilitate one or more cooling operations for the component(s). In this manner, the climate control infrastructure can facilitate climate control for an aerial vehicle to prevent overheating and ensure quality and comfort during a transportation service.

A computing system can coordinate the actions of the climate control infrastructure at an aerial transport facility to efficiently and safely manage the temperature of component(s) of a plurality of aerial vehicles that are arriving and departing from the aerial transport facility (e.g., while an aircraft is parked at the aerial transport facility). To do so, the computing system can determine a climate control configuration for the climate control infrastructure that identifies a desired thermal condition associated with an aerial vehicle. The climate control configuration can be determined based on thermal parameters for the aerial vehicle that identify a current temperature of component(s) (e.g., cabin, hardware, power source, etc.) of the vehicle and a threshold temperature for those component(s). A desired thermal condition can identify a target temperature that achieves a threshold temperature for a respective component. The computing system can generate and communicate command signal(s) indicative of the climate control configuration to the climate control infrastructure and/or one or more devices of the climate control infrastructure to instruct the infrastructure and/or devices to implement cooling procedures in accordance with the climate control configuration. In this manner, the systems and methods of the present disclosure can dynamically coordinate climate control procedures for multiple aerial vehicles at an aerial transport facility at any given time. This, in turn, allows the computing system to effectively manage limited resources (e.g., cooling materials, power supplies, etc.) of a central climate control infrastructure. In this way, the computing system can enable safe and efficient vehicle cooling, which can increase the safety of aerial travel. In addition, the climate control infrastructure reduces the need for and/or the robustness of onboard climate control systems within aerial vehicles. This can be beneficial for aerial vehicle weight reduction. Accordingly, the computing system described herein can enable further development and safe operation of aerial vehicles.

More particularly, a service entity can be associated with an operations computing system (e.g., a cloud-based operations computing system, etc.) that is configured to manage, coordinate, and dynamically adjust a multi-modal transportation service via a transportation platform. The multi-modal transportation service can include a plurality of transportation legs, one of which (e.g., a second transportation leg) can include an aerial transport of a user. For example, the operations computing system can obtain a request for a transportation service. The request for the transportation service can include at least a request for an aerial transport of a user of the transportation platform. The operations computing system can obtain the request from a user device associated with the user of the transportation platform.

The request for the transportation service can include an origin location and a destination location. In some instances, unless specified otherwise, the origin of the transportation service can be assumed to be a current location of the user (e.g., as indicated by location data such as GPS data received from the user device and/or as input by the user). A user can also supply a desired destination (e.g., by typing the destination into a text field which may, for example, provide suggested completed entries while the user types).

A multi-modal transportation itinerary from the origin location to the destination location can be generated based on the request for the transportation service. The multi-modal transportation itinerary can include two or more transportation legs (e.g., a first transportation leg, a second transportation leg, a third transportation leg, etc.) between the origin location and the destination location specified in the request. The two or more transportation legs can include travel via two or more different transportation modalities such as, for example: cars, motorcycles, light electric vehicles (e.g., electric bicycles or scooters), buses, trains, aircraft (e.g., airplanes), watercraft, walking, and/or other transportation modalities. Example aircrafts can also include helicopters and other vertical take-off and landing aircraft (VTOL) such as electric vertical take-off and landing aircraft (eVTOL). The vehicles can include non-autonomous, semi-autonomous, and/or fully-autonomous vehicles.

For example, an autonomous vehicle (e.g., ground vehicle, aircraft, etc.) can include various systems to allow the vehicle to operate autonomously (e.g., with little or no input from an operator). For example, an autonomous vehicle can include a routing system, a positioning system, a motion planning system, and one or more vehicle control systems. The routing system can generate (onboard the vehicle) and/or obtain (from a remote computing device) a route for the vehicle to follow from one location to one or more other locations. The positioning system can determine a current position of the vehicle. The positioning system can be any device or circuitry for analyzing the position of the vehicle. For example, the positioning system can determine position by using one or more of inertial sensors, a global positioning system/satellite positioning system, based on IP/MAC address, by using triangulation and/or proximity to network access points or other network components (e.g., cellular towers and/or Wi-Fi access points) and/or other suitable techniques. The position of the vehicle can be used by various systems of the vehicle computing system and/or provided to one or more remote computing devices (e.g., cloud services system).

The vehicle can identify its position within its environment and/or along a route. The vehicle can obtain map data that can provide the vehicle relative positions of the surrounding environment of the vehicle (e.g., buildings, aerial facilities, landing areas, etc.). The vehicle can obtain route data indicative of a route to be followed (e.g., to travel from one aerial facility to another). The vehicle can identify its position within the surrounding environment based at least in part on the data described herein to help follow along the route. For example, the vehicle can process sensor data (e.g., LIDAR data, camera data, positioning data, etc.) from sensors onboard the vehicle to match it to a map of the surrounding environment and/or a route to get an understanding of the vehicle's position within that environment and/or along the route (e.g., transpose the vehicle's position within its surrounding environment/route).

In some implementations, an autonomous vehicle (e.g., aircraft) can include a perception system and/or a prediction system, and/or other systems that cooperate to perceive and predict the states of the surrounding environment of the vehicle. For instance, the vehicle can obtain sensor data from one or more onboard sensors. The vehicle can detect object(s) (e.g., other aircraft, etc.) within its environment via the perception system and determine the state of the detected object(s) (e.g., type, shape, size, position, velocity, speed, heading, etc.) at one or more times by processing the sensor data (e.g., utilizing machine-learned models, heuristics, etc.).

The vehicle can predict the motion of those object(s) via the prediction system. For example, the vehicle can utilize the state of a detected object at one or more past/current times to predict a motion plan of an object at one or more future times. The predicted path (e.g., trajectory, waypoints, etc.) can indicate a path along which the respective object is predicted to travel over time (and/or the velocity at which the object is predicted to travel along the predicted path).

The autonomous vehicle can utilize its motion planning system to plan the vehicle's motion. For example, the motion planning system can generate vehicle trajectories for the vehicle to follow along a route. The vehicle trajectories can be a certain length (e.g., 10 ft, 50 ft., 100 ft., 500 ft., etc.) and can be determined at a particular frequency (e.g., 1 second or less, etc.). In some implementations, the motion planning system can determine the vehicle trajectories based at least in part on the state data (determined by the perception system) and/or the predicted object motion (determined by the perception system). This can allow the vehicle to avoid interference with any object(s) within its surroundings. The motion planning system can generate a plurality of candidate vehicle trajectories at a time and select a vehicle trajectory for execution (e.g., based on cost functions, reward functions, penalties, etc.). For example, the motion planning system can select a vehicle trajectory that avoids interfering with the object(s) within the vehicle's surroundings (e.g., with a buffer distance) while also minimizing deviation from the vehicle's route and/or skylane. The selected trajectory can be provided to the vehicle control systems (e.g., associated with a throttle interface, steering interface, etc.) for execution to adjust the vehicle's speed, position (e.g., altitude, longitudinal position, latitudinal position, etc.), orientation (e.g., yaw, pitch, roll, etc.), and/or other motion parameters. In some implementations, the selected trajectory can be translated into instructions that can be implemented by these control system(s). In this way, a vehicle (e.g., aircraft) described herein can autonomously navigate/travel from one location to another (e.g., while traversing an assigned route).

The operations computing system can facilitate the ability of a user to receive transportation on one or more of the transportation legs included in the multi-modal transportation itinerary. As an example, the operations computing system can interact with a plurality of devices (e.g., one or more service provider devices) to match the user with one or more transportation service providers for each transportation leg of the multi-modal transportation itinerary. For example, the operations computing system can book or otherwise reserve a seat in, space on, or usage of one or more of the transportation modalities for the user. For example, the request for a transportation service can include at least an aerial transport of the user. In response, the operations computing system can determine an aerial service provider to provide the aerial transport for the user (e.g., book a seat on an aircraft of the aerial service provider).

In this manner, the operations computing system can generate a multi-modal transportation itinerary for facilitating the aerial transportation of the multi-modal transportation service. The multi-modal transportation itinerary can include at least a first transportation leg, a second transportation leg, and a third transportation leg. An aerial service provider, for example, can be associated with the second transportation leg to provide the aerial transport to the user during the second transportation leg.

The aerial transport can include transportation between at least two aerial transport facilities. An aerial transport facility can be located on a roof of a structure, such as a parking garage and can provide landing, take-off, parking, and/or charging or cooling locations for one or more aircraft of an aerial service provider. For example, the aerial transport facility can include a landing area with one or more landing pads where an aerial vehicle can land at and/or depart from the aerial transport facility, one or more parking locations where an aerial vehicle can park in between aerial transport services, one or more charging locations where an aerial vehicle can charge (and/or refuel) before departure, and/or one or more cooling locations where one or more components of an aerial vehicle can be cooled down. In some implementations, one or more parking location(s) can include one or more charging and/or cooling locations. For instance, a parking location, cooling location, and a charging location can include the same location within a landing area of an aerial transport facility.

A computing system (e.g., an operations computing system, aerial transport facility computing system, etc.) can be configured to control, route, monitor, and/or communicate with aircraft in the vicinity of the aerial transport facility. The computing system can be configured to determine or aid in determining respective routes for the aircraft for landing on the aerial transport facility and/or taking-off from the aircraft transport facility. In addition, or alternatively, the computing system can determine respective landing pad locations on which the aircraft can land and/or depart from and/or one or more parking, charging, and/or cooling locations to which the aircraft can travel once landed at the landing area. The computing system, for example, can determine a location for an aircraft to receive one or more climate control operations from a climate infrastructure of the aerial transport facility. The climate control operation(s), for example, can be implemented to cool one or more components (e.g., cabin, hardware, power source, etc.) of an aerial vehicle before the aerial vehicle is scheduled to depart the transportation facility (e.g., take-off from the landing area).

For example, an aerial transport facility of the present disclosure can include a climate control infrastructure. The climate control infrastructure can include one or more climate control computing systems on the landing area of the aerial transport facility. For example, the climate control infrastructure can include a central climate control system and/or a plurality of climate control devices. The central climate control system, for example, can include a central cooling distribution system (e.g., chilling plant, heating, ventilation, and air conditioning (HVAC) system, glycol air cooler system, etc.) configured to distribute thermal material (e.g., air, liquid, liquid cooled air, antifreeze, etc.) to one or more locations (e.g., cooling locations), aerial vehicles, and/or climate control device(s) on the landing area. In this regard, the central climate control system can include one or more heat exchangers, motors (e.g., blower motors, etc.), combustion chambers, coil (condenser coils, evaporator coils, etc.), compressors, thermostats, and/or any other mechanism for facilitating the climate control operations described herein. In some implementations, the central climate control system can be configured to service each of the one or more parking locations, charging locations, and/or cooling locations of the landing area. For instance, the central climate control system can branch out (e.g., via one or more cables, pipes, etc.) to each location and/or aerial vehicle of the landing area.

The central climate control system can interact with a plurality of climate control devices to implement one or more climate control operations. For example, the plurality of climate control devices can include a fleet of robotic climate control devices configured to service (e.g., by performing one or more climate control operations) multiple aerial vehicles. The central climate control system, for instance, can be configured to supply power, cooling materials, etc. to the fleet of robotic climate control devices to enable the devices to service the multiple vehicle. The fleet of robotic climate control devices can include a variety of robotic devices including, for example, one or more stationary climate control device(s) and/or one or more mobile climate control device(s).

A stationary climate control device, for example, can include an interfacing component (e.g., robotic arm and/or one or more other components capable of interfacing with component(s) of an aerial vehicle) having an end that is stationary with respect to a surface on which the aerial vehicle sits (e.g., a landing area surface, parking surface, etc.). For example, the end of the interfacing component can be mounted, tethered, coupled, etc. to the surface of a structure coupled to the surface of the landing area (e.g., a covering, a support structure of a covering, etc.). In some implementations, for example, the interfacing component can be mounted to a stationary charging device mounted to the surface of the landing area.

Alternatively, the climate control device can be mobile (e.g., on tracks or wheels). The mobile climate control device can include an interfacing component mounted to a mobile surface (e.g., a battery powered platform with one or more wheels). In some implementations, for example, the interfacing component can be mounted to a mobile charging device. The mobile climate control device can travel (e.g., via the mobile platform, mobile charging device, etc.) to an aerial vehicle to service component(s) of the aerial vehicle.

The interfacing component of the climate control device(s) can be configured to operatively interface with one or more aerial components (e.g., a cabin, power source, hardware, etc.) of an aerial vehicle to facilitate one or more climate control operations (e.g., cool down a power source, cabin, hardware, etc.). For example, the interface component can include at least one climate control interface. The climate control interface(s) can include one or more power source interface(s) (e.g., configured to interface with a power source of an aerial vehicle), one or more cabin interface(s) (e.g., a blower configured to interface with a cabin of an aerial vehicle (e.g., by forcing cool air into a cabin)), and/or a one or more of hardware interface(s) (e.g., configured to interface with hardware (e.g., dashboards, seats, railings) within the cabin of an aerial vehicle). In this manner, the central climate control system can interface with a plurality of aircraft components through the climate control device(s) (e.g., by supplying the fleet of climate control device(s)) at one or more locations of the landing area. For instance, the climate control device(s) can include at least one stationary and/or mobile climate control device at each landing pad, parking location, cooling location, charging location, and/or any other location of the landing area.

The plurality of climate control device(s) can include a power supply (e.g., a battery, power interface, etc.), cooling supply (e.g., cool water, air, gas, etc.), one or more climate control interface(s) (e.g., of the interface component(s)), network devices (e.g., communication interfaces such as one or more radio frequency devices, etc.), and/or one or more sensors (e.g., location sensors (e.g., GPS), cameras, etc.). For example, one or more of the climate control device(s) (e.g., the stationary climate control devices) can include a power interface (e.g., cable, etc.) connected to a central power supply (e.g., of the central climate control system). In addition, or alternatively, one or more of the climate control device(s) (e.g., the mobile climate control devices) can include one or more mobile power sources. The mobile power source(s) for instance can include one or more batteries (e.g., thermal batteries, lithium ion batteries, etc.) capable of receiving and storing a charge. For instance, the mobile power source(s) can include a power interface configured to connect to the central power supply to resupply energy stored by the mobile power source(s).

The cooling supply can include cooling material(s) usable by the one or more climate control interfaces of the plurality of climate control device(s) to service component(s) of an aerial vehicle. Cooling material(s), for instance, can include air (cool air, compressed air, one or more gasses), liquid (cold water, liquid nitrogen, etc.), and/or one or more cooling solids (e.g., ice, coils, etc.) configured to lower the temperature of one or more aircraft components. As an example, a cooling material can include one or more metal coils configured to retain low temperatures. As another example, a cooling material can include cold water previously chilled, for example, by the central climate control system. The cooling materials can include one or more exhaustive resource. For instance, a metal coil and/or previously chilled water can retain a low temperature for a limited time period. In such a case, the central climate control system can include a central cooling supply. The respective climate control device can interact with the central climate control system to refill (and/or rechill) the cooling material of the respective climate control device's cooling supply. In some implementations, each device of the plurality of climate control device can include a cooling supply with a threshold level of cooling material sufficient to cool multiple vehicle throughout a travel day.

The cooling material(s) of a climate control device(s) cooling supply can be applied by climate control interface(s) to a respective aerial component to modify the temperature of the aerial component. For example, a respective climate control device can utilize the cooling material and one or more respective climate control interfaces to cool one or more aerial components of a respective aerial vehicle. By way of example, a cabin climate control interface can include a heat exchanger with fan. The fan can be configured to blow air over a cooling material (e.g., cold water, liquid nitrogen, etc.) to funnel cool air intro a cabin of an aerial vehicle. As another example, a power source climate control interface can include a rod, pipe, etc. configured to be inserted through and/or otherwise around power source of an aerial vehicle. The power source climate control interface can be previously cooled by one more cooling materials before it is placed near the power source. In addition, or alternatively, the power source climate control interface can include one or more pumps configured to circulate a cooling material within the power source climate control interface (e.g., a rod, pipe, etc.) before, after, and/or while the power source climate control interface is placed near the power source. A hardware climate control interface can include any of the above mentioned interfaces. For example, a hardware climate control interface can include a heat exchanger fan, a rod, pipe, etc. and/or any other cooling mechanism. In this manner, a climate control device can interact with a central cooling system (e.g., to obtain cooling material and/or power) to cool one or more components of an aerial vehicle.

In some implementations, an aerial vehicle can include a respective power source of a plurality of different power sources. For instance, an aerial vehicle can include an electric aerial vehicle powered by one or more batteries (e.g., thermal batteries, lithium batteries, etc.). One or more different electric aerial vehicles can include one or more different battery types. Each battery type can be configured to interface with a different power source climate control interface. In such a case, the fleet of climate control devices can include a plurality of different power source climate control interfaces, each configured to interface with and/or cool a respective battery type (e.g., grouped by manufacturer, cooling process, etc.). For instance, each of the plurality of climate control devices can include one or more of the different power source climate control interfaces. In some implementations, each device can include a power source climate control interface for each of the different power source types.

Each device of the plurality of climate control device(s) can be associated with device data. The device data can be indicative of one or more device parameters such as, for example, a device type, device supply, device location (e.g., dynamic location coordinates for mobile devices, static coordinates for static devices, etc.), device power level, assignment data, device state data, and/or any other information to facilitate climate control operations for multiple aerial vehicles. The device supply, for example, can be indicative of a current amount and type of cooling material stored and/or otherwise accessible to a respective device. The power level can be indicative of a current amount of power accessible to the respective device. In addition, in some implementations, the power level can include power usage data that identifies a level of power currently used by a respective device (e.g., to service a component of an aerial vehicle), a level of power expected to be used by the respective device (e.g., to implemented a climate control operation for aerial component(s)), and/or a level of power previously used (e.g., power used during the course of implementing one or more previous climate control operations).

The device type can be indicative of one or more interfacing capabilities of a respective device. For example, a device type can indicate one or more aerial components of one or more aerial vehicles that a respective device is capable of servicing (e.g., cooling). For instance, the device type can indicate one or more climate control interfaces of a respective climate control device. By way of example, a cabin device type can be capable of servicing cabin components of an aerial vehicle. To do so, a climate control device associated with a cabin device type can include one or more cabin climate control interfaces. As another example, a respective power source device type can be capable of servicing a respective power source of an aerial vehicle. To do so, a climate control device associated with the respective power source device type can include one or more power source climate control interfaces configured to interface with the respective power source type of the aerial vehicle.

The device state data can include a current state of a respective climate control device. A current state can be indicative of a busy state indicating that the device is carrying out an assignment, a low resource state indicating that the device is associated with a low power level and/or supply level, etc. The assignment data can be indicative of one or more climate control assignments for a respective climate control device. For example, the assignment data can include one or more control instructions to carry out one or more portions of a climate control configuration to service one or more components of an aerial vehicle. As described in more detail with reference to the climate control configuration, the assignment data can include a respective aerial component, a time, a desired temperature, and/or any other information associated with coordinating climate control.

A computing system can interact with the climate control infrastructure (e.g., central climate control system, fleet of climate control devices, etc.) of an aerial transport facility to coordinate the climate control of a plurality of aerial vehicle at or scheduled to be at the aerial transport facility. To do so, the computing system can obtain climate control related data. The climate control related data can include data associated with a multi-modal transportation service (e.g., itinerary data), vehicle data associated with one or more aerial vehicles, facility data associated with an aerial transport facility, and/or any other data relevant to managing climate control for an aerial vehicle.

For example, a computing system can obtain data associated with a multi-modal transportation service. The data associated with the multi-modal transportation service can include itinerary data indicative of one or more itineraries for one or more aerial vehicles. The one or more aerial vehicles, for example, can include a first vehicle for facilitating the multi-modal transportation service. For example, the one or more flight itineraries can include a flight itinerary for each of a plurality of aerial vehicles associated with a transportation service provider. Each flight itinerary can include one or more transports from one or more first aerial facilities to one or more second aerial facilities. Each transport, for instance, can include an origin facility, a departure time, an arrival facility, and/or an arrival time. Thus, an itinerary with multiple transports can include an origin facility, a first departure time, a first destination facility, an arrival time, a second destination facility, and a second departure time. In such a case, the itinerary can indicate a parking time at the first destination facility between the arrival time and the second departure time.

The one or more itineraries can include a first itinerary for the first aerial vehicle (e.g., for facilitating the multi-modal transportation service) and/or one or more second itineraries for one or more second aerial vehicles. The first and/or second itineraries can be indicative of at least an aerial transport facility at which the first aerial vehicle and/or second aerial vehicle(s) are to be located (e.g., a destination facility). In addition, or alternatively, the first and/or second itineraries can be indicative of an arrival time of the first and/or second aerial vehicle(s) at the aerial transport facility, a departure time from the aerial transport facility, and/or one or more subsequent destination facilities (and/or one or more payloads (e.g., weight) for a transport to the subsequent destination facility). In addition, the first and/or second itineraries can include a parking time at the aerial transport facility (e.g., the time between the arrival time and the departure time). In this manner, the data indicative of a multi-modal transportation service (e.g., the itinerary data) can be indicative of an estimated time period for which the first and/or second aerial vehicles will be located at the aerial transport facility.

In addition, the computing system can obtain vehicle data for the first aerial vehicle and/or the one or more second aerial vehicles. For example, the computing system can obtain vehicle data associated with the one or more aerial vehicles. The vehicle data can be indicative of vehicle layout, one or more thermal parameters, charging parameters (e.g., a current charge level, etc.), and/or any other climate control information associated with the one or more aerial vehicles. A vehicle layout, for example, can be indicative of one or more components of a respective aerial vehicle. For instance, the vehicle layout can identify dimensions of a vehicle cabin, a material (e.g., metal, plastic, leather, etc.) of one or more hardware components (e.g., a dashboard, seat, railing, etc.) within the vehicle cabin, and/or a power type (e.g., battery type, motor type, etc.) of a vehicle power source (e.g., battery, motor, etc.). By way of example, the one or more aerial vehicles can include one or more different batteries manufactured by one or more different manufactures. The vehicle layout can identify the type of power source of a respective aerial vehicle and a type of power source climate control interface that can interface with the type of power source. In some implementations, the vehicle layout can be indicative of how the vehicle thermal management may be provided onboard the vehicle (e.g., by distributing cabin heat to the batteries, using an onboard refrigerant system, ventilation systems, etc.).

The one or more thermal parameters can include one or more temperatures associated with aircraft component(s) of an aerial vehicle. For example, an aerial vehicle can include a plurality of thermal sensors distributed throughout the vehicle (e.g., the cabin, hardware, power source, etc.). The plurality of thermal sensors can be configured to measure a temperature associated with the component(s) of the aerial vehicle. For instance, the aerial vehicle can include a cabin thermal sensor configured to measure the air temperature within the cabin of the aerial vehicle. As another example, the aerial vehicle can include cabin hardware thermal sensor(s) configured to measure the temperature of one or more hardware components within the cabin of the aerial vehicle. In addition, the aerial vehicle can include a power source thermal sensor configured to measure the temperature of one or more power sources of the aerial vehicle. In this manner, the aerial vehicle can collect temperature sensor data indicative of the temperature of the different component(s) of the aerial vehicle.

In some implementations, the one or more thermal parameters can include a current temperature for the component(s) of the aerial vehicle. By way of example, the thermal parameter(s) can include a current cabin temperature indicative of the current air temperature within the cabin of the aerial vehicle, a current hardware temperature indicative of the surface temperature of the one or more hardware components within the cabin of the aerial vehicle, a current power source temperature indicative of the internal temperature of the one or more power sources of the aerial vehicle, and/or the current temperature of any other component of the aerial vehicle.

In addition, or alternatively, the one or more thermal parameters can include one or more threshold temperatures. The one or more threshold temperatures can be indicative of a maximum and/or minimum acceptable temperature for each component of the aerial vehicle. The one or more threshold temperatures can include a different threshold for each component(s) of the aerial vehicle. For example, a power source for an aerial vehicle can be associated with a battery temperature threshold indicative of the highest internal temperature allowable for safe operation of the battery. For instance, the highest internal temperature can include an internal temperature at which the battery can be at risk of overheating. As another example, a cabin for an aerial vehicle can be associated with a cabin temperature threshold indicative of the highest temperature at which passenger may begin to feel discomfort during a transportation service. The battery temperature threshold can include a temperature that is higher than the cabin temperature threshold. For instance, a passenger may begin to feel discomfort at temperature lower than a temperature capable of causing a battery to overheat.

In some implementations, the computing system can obtain facility data associated with an aerial transport facility for providing the multi-modal transportation service. For example, the facility data can be associated with the aerial transport facility at which the first aerial vehicle and/or second aerial vehicle(s) are to be located (e.g., a destination facility). For instance, the one or more aerial vehicles can utilize the aerial transport facility to provide the multi-modal transportation service. The facility data can be indicative of a climate control infrastructure at the aerial transport facility. For example, the facility data can include infrastructure data indicative of the system data and/or device data for the central climate control system and/or the plurality of climate control devices of the climate control infrastructure at the aerial transport facility.

In addition, the facility data can include capacity data. The capacity data can identify one or more energy and/or climate control limits of the climate control infrastructure. For instance, the capacity data can include an overall energy capacity indicative of the total power level (e.g., voltage, watts, etc.) accessible to the aerial transport facility (e.g., for use by the climate control infrastructure, one or more charging device, etc.). In addition, the capacity data can include current use data indicative a current power usage of the aerial transport facility. The current use data, for example, can be determined based on the power usage data associated with each of the plurality of climate control devices of the climate control infrastructure. In some implementations, the capacity data can include an available capacity indicative of a power level (e.g., a wattage) available for charging and/or cooling operations. The available capacity data can include currently available capacity data indicative of the available capacity at a current time and/or one or more future available capacities indicative an available capacity at one or more future times. For example, the currently available capacity data can be determined based on the overall energy capacity and the current use data (e.g., by subtracting the current use data from the total power capacity).

The computing system can determine a climate control configuration for the climate control infrastructure at the aerial transport facility for at least the first aerial vehicle that is located and/or scheduled to be located at the aerial transport facility. The climate control configuration can include an assignment of one or more climate control devices to service the first aerial vehicle, a time to service the first aerial vehicle, one or more cooling operations to implement for the first aerial vehicle, and/or any other information for managing climate control for the first aerial vehicle. For instance, the climate control configuration can identify at least a portion of the climate control infrastructure at the aerial transport facility for cooling hardware of the aerial vehicle, a cabin of the aerial vehicle, and/or a power system of the aerial vehicle.

The computing system can determine the climate control configuration based on the data associated with the multi-modal transportation service, the one or more thermal parameters of the first aerial vehicle, the facility data associated with the aerial transport facility, and/or any other data associated with maintaining the climate of one or more components of the first aerial vehicle. For example, the climate control configuration can identify a climate control device to service (e.g., cool) one or more components (e.g., the hardware, cabin, power system, etc.) of the first aerial vehicle based on device data associated with each of the plurality of climate control devices and/or vehicle data associated with the first vehicle.

For instance, the climate control configuration can include an assignment of the climate control device to the first aerial vehicle (and/or one or more components of the aerial vehicle). In some implementations, the computing system can identify the climate control device based on the device data associated with each of the climate control devices of the climate control infrastructure at the aerial transport facility and/or the vehicle data associated with at least the first aerial vehicle. For example, the computing system can assign the climate control device to service the first aerial vehicle based on the respective location of the aerial vehicle and/or the climate control device, the thermal parameters of the aerial vehicle and/or the cooling supply of the climate control device, the vehicle layout of the aerial vehicle and/or the device type of the climate control device, the first flight itinerary of the aerial vehicle and/or the assignment data of the climate control device, and/or any other climate control related factors.

By way of example, the computing system can identify the climate control device by determining that the climate control device is within a proximity to the aerial vehicle (e.g., based on the vehicle location and the device location), the climate control device has a threshold level of cooling material to service the aerial vehicle (e.g., based on the thermal parameters of the aerial vehicle and the cooling supply of the climate control device), the climate control device can interface with one or more components of the aerial vehicle (e.g., based on the vehicle layout of the aerial vehicle and the device type of the climate control device), and/or that the climate control device is available to service the first aerial vehicle (e.g., based on the first flight itinerary of the aerial vehicle and/or the assignment data of the climate control device). In this manner, the computing system can assign a climate control device to service at least one component of the first aerial vehicle such that the climate control device is capable and/or available to perform one or more climate control operations for the at least one component of the first aerial vehicle.

More specifically, the climate control configuration can include one or more climate control parameters such as, for example, a climate control time period, a climate control location, one or more desired thermal conditions (e.g., a desired thermal condition for each component (e.g., cabin, power system, hardware, etc.) of the first aerial vehicle), and/or an energy allocation. For example, determining the climate control configuration can include determining one or more desired thermal conditions. A respective desired thermal condition for the aerial vehicle can include a desired temperature for a respective component of the first aerial vehicle to reach before departing from the aerial transport facility.

In some implementations, the computing system can monitor, via one or more thermal sensors of the first aerial vehicle, the one or more thermal parameters of the first aerial vehicle. In such a case, the computing system can detect that at least one of the thermal parameter(s) has achieved, is estimated to achieve, and/or is within a range of a respective threshold temperature for a corresponding component of the first aerial vehicle. In some implementations, the computing system can determine the climate control configuration for the climate control infrastructure at the aerial transport facility for the first aerial vehicle in response to detecting that the at least of the one of the one or more thermal parameters has achieved the at least one of the one or more threshold temperatures.

The computing system can determine the one or more desired thermal conditions for the first aerial vehicle to reach before departing from the aerial transport facility based on one or more climate control factors. The one or more desired thermal conditions, for example, can be based on the first flight itinerary (e.g., a parking time at the aerial transport facility, an upcoming flight, etc.), the thermal parameter(s) of the first aerial vehicle, and/or the threshold temperatures associated with each component of the first aerial vehicle. By way of example, each of the one or more desired thermal conditions can be indicative of a desired temperature for at least one component of the first aerial vehicle. The desired temperature can include a temperature below a respective threshold temperature associated with each component of the first aerial vehicle. The computing system can determine a desired thermal condition by comparing a thermal parameter associated with a respective component of the first aerial vehicle to a threshold temperature associated with the respective component. Achieving the desired thermal condition can include lowering the temperature (e.g., as indicated by the thermal parameter) of the respective component below the threshold temperature.

The one or more desired thermal conditions, for example, can be based on one or more aspects of the first flight itinerary. For instance, the desired thermal conditions can be based on one or more upcoming flights for the aerial vehicle after departing the aerial transport facility. For instance, the desired thermal condition for a respective component can include a temperature below a respective threshold temperature for the respective component such that a respective component does not reach the respective threshold temperature during an upcoming flight. For example, a component (cabin, hardware, power system, etc.) of the aerial vehicle can retain heat during a flight. In such a case, the computing system can determine an estimated temperature increase for each component of the aerial vehicle based on the time and/or one or more other aspects (e.g., payload, number of passengers, type of cargo, etc.) of the upcoming flight. Accordingly, the one or more desired thermal conditions can be determined based on the estimated time and/or the one or more other aspects (e.g., payload, number of passengers, type of cargo, etc.) of the upcoming flight. For instance, the one or more desired thermal conditions can be determined based on the estimated temperature increase during the upcoming flight.

The climate control location can be indicative of an assigned location to service the first aerial vehicle. The assigned location, for example, can include a parking location, charging location, cooling location, etc. of the landing area of the aerial transport facility. In some implementations, the assigned location can be determined based on the assigned climate control device. By way of example, the assigned location can include a parking location, charging location, cooling location, etc. of the landing area where a stationary climate control device assigned to service the aerial vehicle is located. In addition, or alternatively, the assigned location can be a scheduled location based on the landing area and/or state (e.g., occupied, available, etc.) of one or more locations (e.g., parking, cooling, charging, etc.) of the landing area. In some implementations, the climate control device can be assigned to service the first aerial vehicle based on the assigned location. For instance, the climate control device can include a stationary climate control device located at the assigned location and/or a mobile climate control device within a proximity to the assigned location.

The climate control time period can be indicative of an estimated time to achieve the one or more desired thermal conditions of the climate control configuration. The climate control energy allocation can be indicative of an estimate power level (e.g., wattage) to achieve the one or more desired thermal conditions of the climate control configuration. For example, the computing system can determine a climate control energy allocation for at least the first aerial vehicle. The climate control energy allocation can be indicative of an amount of energy sufficient to achieve a desired thermal condition for the aerial vehicle. In some implementations, the climate control energy allocation can correspond to the climate control time period. For instance, the energy allocation can include a power level (e.g., wattage) over time. In some implementations, the energy allocation can increase as the climate control time period decreases. For instance, the energy allocation can include a total energy expense for achieving the one or more desired thermal conditions. The total energy expense can be spread out over the climate control time period such that a longer climate control time period can result in a lower energy allocation over time and a shorter climate control time period can result in a higher energy allocation over time.

In some implementations, the computing system can determine the climate control configuration (e.g., a climate control time period, energy allocation, etc.) for the climate control infrastructure based on one or more charging parameters associated with the first aerial vehicle and/or the one or more second aerial vehicles. For instance, the computing system can determine charging parameters for the first aerial vehicle and/or the one or more second aerial vehicles based at least in part on the vehicle data. The charging parameters, for example, can include a current charge level for a power system of the aerial vehicle. The computing system can determine charging resources for the first aerial vehicle and the one or more second aerial vehicles at the aerial transport facility based at least in part the charging parameters. For instance, the charging resources can include charging energy allocations for each of the first and second aerial vehicles. A respective charging energy allocation can be indicative of an amount of energy sufficient to charge an associated aerial vehicle, for example, to complete an upcoming flight.

The computing system can determine the climate control configuration for the climate control infrastructure at the aerial transport facility for a first aerial vehicle based at least in part on the charging resources. For instance, the computing system can determine an overall energy allocation at the aerial transport facility based on the charging energy allocation for each of the first and second aerial vehicles and the climate control energy allocation for the first aerial vehicle and/or the one or more second aerial vehicles. The overall energy allocation can be indicative of an allocation of energy for facilitating the charging of each of the first and second aerial vehicles and an allocation of energy for facilitating the climate control configuration for the first aerial vehicle and/or second aerial vehicles. The overall energy allocation, for example, can include an allocation of energy over time. The computing system can determine the climate control energy allocation such that the overall energy allocation does not exceed the overall energy capacity of the aerial transport facility at any given time.

In addition, or alternatively, the computing system can determine the climate control configuration based at least in part on the estimated time period for which the first aerial vehicle will be located at the aerial transport facility. For example, the computing system can determine the climate control configuration for the first aerial vehicle to reach a desired thermal condition within the estimated time period. By way of example, the computing system can determine the climate control time period such that climate control time period is within the estimated time period. In this manner, the climate control configuration can include a climate control energy allocation that depends on the estimated time period. For instance, the computing system can determine a higher climate control energy allocation over time for shorter estimated time periods and a lower climate control energy allocation over time for longer estimated time periods.

In some implementations, the computing system can determine the climate control configuration for the climate control infrastructure at the aerial transport facility for the first aerial vehicle based on environmental data. For instance, the computing system can obtain environmental data indicative of one or more thermal environmental factors (e.g., outside temperature, wind chill, humidity, weather, etc.) associated with an operating environment of the first vehicle. The computing system determine one or more aspects of the climate control configuration based on the one or more thermal environmental factors. For instance, the climate control energy allocation can be determined based the one or more thermal environmental factors. By way of example, a higher climate control energy allocation can be determined in the event that the outside temperature is higher than a desired thermal condition. Moreover, a lower climate control energy allocation can be determined in the event that a wind chill or rain lowers the outside temperate below a desired thermal condition.

In addition, or alternatively, the climate control configuration can include one or more climate control processes. The climate control processes can identify a method of achieving a desired thermal condition for a component of an aerial vehicle. By way of example, a climate control process can specify a respective climate control interface for implementing a climate control operation (e.g., a cooling fan to cool a cabin of an aerial vehicle, a cooling rod to cool a power source of a vehicle, etc.). In some implementations, a climate control process can depend on the one or more environmental factors. For instance, the effectiveness of a climate control interface can depend on the one or more environmental factors. By way of example, a climate control interface such as a cooling fan configured to blow cool air over cold water can be more effective in drier climates and less effective in humid environments. In such a case, the computing system can determine climate control device based on an estimated effectiveness of one or more climate control interfaces of the climate control device in the operating environment of the aerial vehicle.

In this manner, the computing system can determine a climate control configuration to service one or more aerial vehicles at the aerial transport facility. As discussed herein, the climate control configuration can include an assignment of at least one climate control device of a climate control infrastructure to service a first aerial vehicle. By way of example, the assignment can include a reservation and an energy allocation for a stationary climate control device and/or a reservation, an energy allocation, and/or a cooling location for a mobile climate control device.

The computing system can generate one or more command signals associated with controlling the climate control infrastructure at the aerial transport facility. The command signals, for example, can be indicative of the climate control configuration. For example, the command signals can include an indication of one or more components of the first aerial vehicle to be serviced, an interface for servicing the one or more components, etc. The climate control device(s) can implement the climate control configuration, via the one or more climate control interfaces, in response to the command signals.

For instance, the computing system can include a cloud computing system. In such a case the cloud computing system can communicate the one or more command signals associated with controlling the climate control infrastructure to at the aerial transport facility. As an example, the computing system can communicate the one or more command signals to an aerial transport facility computing system. The aerial transport facility computing system can receive the instructions and control one or more portions of the climate control infrastructure (e.g., the central climate control system, one or more climate control devices, etc.) to implement the climate control configuration in response to the instructions.

As another example, the computing system can include an aerial facility computing system. In such a case, the aerial facility computing system can communicate the one or more command signals to the climate control infrastructure (e.g., a computing system of the central climate control system, one or climate control devices, etc.). In addition, or alternatively, the computing system can include a third party system and/or a vehicle computing system onboard the aerial vehicle. The third party system and/or the vehicle computing system can communicate the one or more command signals to the cloud computing system, the facility computing system, and/or directly to the climate control infrastructure (e.g., a computing system of a central climate control system, one or more of the plurality of climate control devices, etc.). The third party system can be, for example, associated with a vehicle provider associated with one or more vehicles.

Example aspects of the present disclosure can provide a number of improvements to computing technology such as, for example, aerial transportation computing technology. For instance, the systems and methods of the present disclosure provide an improved approach for facilitating climate control for multiple aircraft. For example, the computing system can obtain data associated with a multi-modal transportation service. The data associated with the multi-modal transportation service can include itinerary data indicative of one or more flight itineraries for one or more aerial vehicles. The computing system can obtain vehicle data associated with the one or more aerial vehicles. The vehicle data can be indicative of one or more thermal parameters of the one or more aerial vehicles. The computing system can obtain facility data associated with an aerial transport facility for providing the multi-modal transportation service. The facility data can be indicative of a climate control infrastructure at the aerial transport facility. The one or more of the aerial vehicles can utilize the aerial transport facility to provide a transportation service. The computing system can determine a climate control configuration for the climate control infrastructure at the aerial transport facility for a first aerial vehicle based at least in part on the data associated with the multi-modal transportation service, one or more thermal parameters of the first aerial vehicle, and the facility data associated with the aerial transport facility. The computing system can communicate the one or more command signals associated with controlling the climate control infrastructure at the aerial transport facility. The command signals can be indicative of the climate control configuration. The computing system can employ improved devices within an aircraft facility that can implement climate control operations for aircraft based on the command signals, thereby reducing the weight of the aircraft by allowing the aircraft to maintain climate control with offboard systems. Moreover, the computing system can accumulate and utilize newly available information such as, for example, data associated with the multi-modal transportation service, one or more thermal parameters of the first aerial vehicle, and the facility data associated with the aerial transport facility to dynamically determine climate control operations. In this way, the computing system provides a practical application that enables an aircraft facility to efficiently facilitate climate control for aircraft during a portion of a transportation service. Ultimately, this can lead to safer and lighter aircraft which can result in a more efficient use of the aircraft's onboard resources (e.g., power resources, processing resources, data resources, etc.).

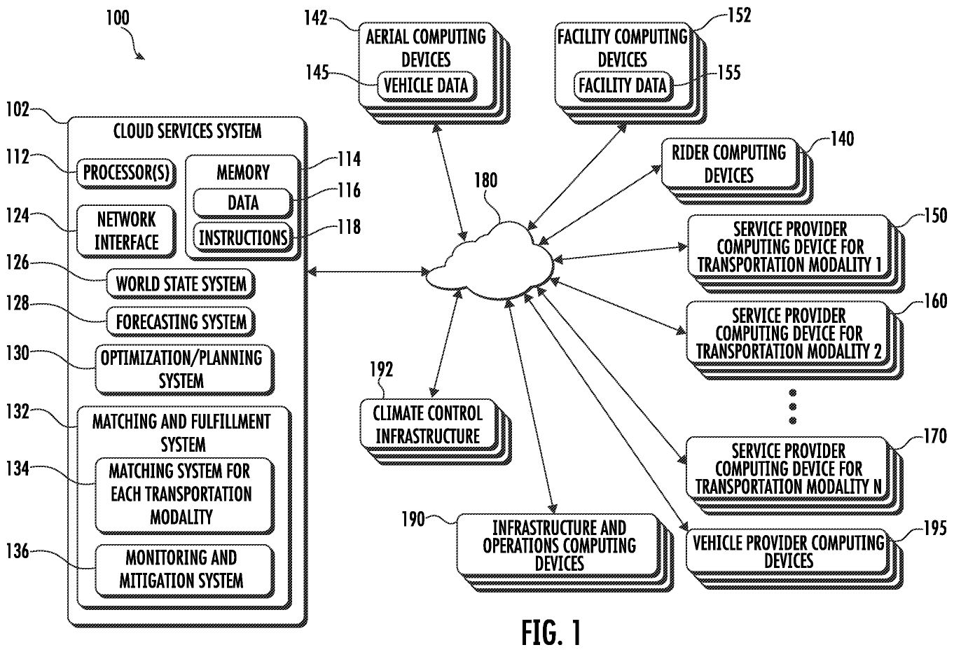

With reference now to FIGS. 1-9, example embodiments of the present disclosure will be discussed in further detail. FIG. 1 depicts a block diagram of an example system 100 according to example embodiments of the present disclosure. The system 100 can include a cloud services system 102 that can operate to control, route, monitor, and/or communicate with aircraft (e.g., VTOL aircraft). These operations can be performed as part of a multi-modal transportation service for passengers, for example, including travel by ground vehicle(s) and travel by aerial vehicle(s) (e.g., VTOL aircraft).

The cloud services system 102 can be communicatively connected over a network 180 to one or more rider computing devices 140, one or more service provider computing devices 150 for a first transportation modality, one or more service provider computing devices 160 for a second transportation modality, one or more service provider computing devices 170 for an Nth transportation modality, one or more infrastructure and operations computing devices 190, and one or more vehicle provider devices 195. In addition, the cloud services system 102 can be communicatively connected over the network 180 to one or more climate control infrastructure(s) 192, one or more aerial computing devices 142, and/or one or more facility computing devices 152. The aerial computing device(s) 142 can store and/or be associated with vehicle data 145. In some implementations, the facility computing device(s) 152 can store and/or be associated with facility data 155. In addition, or alternatively, the one or more facility computing device(s) 152 can be associated with the one or more climate control infrastructure(s) 192.

The cloud services system 102 can be an operations computing system associated with a service entity and be configured to manage, coordinate, and dynamically adjust a multi-modal transportation service via a transportation platform of the service entity. The service entity can include, for example, a transportation network provider. The transportation network provider can be an entity that coordinates, manages, etc. transportation services that include aerial and/or other types of vehicles. The transportation network provider can be associated with one or more transportation platforms. A transportation platform can be utilized for the provision of transportation services via one or more vehicles available, online, etc. to the transportation platform. In some implementations, the vehicles used to provide the transportation services can be owned, operated, leased, etc. by the service entity (e.g., the transportation network provider). Additionally, or alternatively, the vehicles the vehicles used to provide the transportation service be owned, operated, leased, etc. by an entity other than the service entity (e.g., a third party vehicle provider).

Each of the computing devices 140, 142, 150, 152, 160, 170, 190, 192, 195 can include any type of computing device such as a smartphone, tablet, hand-held computing device, wearable computing device, embedded computing device, navigational computing device, vehicle computing device, facility computing device, desktop, laptop, server system, etc. A computing device can include one or more processors and a memory (e.g., similar to as will be discussed with reference to processors 112 and memory 114). Although service provider devices are shown for N different transportation modalities, any number of different transportation modalities can be used, including, for example, less than the three illustrated modalities (e.g., one or more modalities can be used).

The cloud services system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage media, such as RAM, ROM, EEPROM, EPROM, one or more memory devices, flash memory devices, etc., and combinations thereof.

The memory 114 can store information that can be accessed by the one or more processors 112. For instance, the memory 114 (e.g., one or more non-transitory computer-readable storage mediums, memory devices) can store data 116 that can be obtained, received, accessed, written, manipulated, created, and/or stored. In some implementations, the cloud services system 102 can obtain data from one or more memory device(s) that are remote from the system 102.

The memory 114 can also store computer-readable instructions 118 that can be executed by the one or more processors 112. The instructions 118 can be software written in any suitable programming language or can be implemented in hardware. Additionally, or alternatively, the instructions 118 can be executed in logically and/or virtually separate threads on processor(s) 112. For example, the memory 114 can store instructions 118 that when executed by the one or more processors 112 cause the one or more processors 112 to perform any of the operations and/or functions described herein.

The cloud services system 102 can include a number of different systems such as a world state system 126, a forecasting system 128, an optimization/planning system 130, and a matching and fulfillment system 132. The matching and fulfillment system 132 can include a different matching system 134 for each transportation modality and a monitoring and mitigation system 136. Each of the systems 126-136 can be implemented in software, firmware, and/or hardware, including, for example, as software which, when executed by the processors 112 cause the cloud services system 102 to perform desired operations. The systems 126-136 can cooperatively interoperate (e.g., including supplying information to each other).

The world state system 126 can operate to maintain data descriptive of a current state of the world. For example, the world state system 126 can generate, collect, and/or maintain data descriptive of predicted passenger demand; predicted service provider supply; predicted weather conditions; planned itineraries; pre-determined transportation plans (e.g., flight plans) and assignments; current requests; current ground transportation service providers; current transportation node operational statuses (e.g., including re-charging or re-fueling capabilities); current aircraft statuses (e.g., including current fuel or battery level); current aircraft pilot statuses; current flight states and trajectories; current airspace information; current weather conditions; current communication system behavior/protocols; and/or the like. The world state system 126 can obtain such world state information through communication with some or all of the devices 140, 142, 150, 152, 160, 170, 190, 192, 195.

For example, rider computing devices 140 can provide current information about passengers. Rider computing devices 140, for instance, can include one or more user device associated with a passenger of one or more service providers. The rider computing devices 140, can monitor the progress of a respective passenger and provide current information about the passenger to the world state system 126. Devices 142, 150, 160, 170, and/or 195 can provide current information about service providers and/or aircraft utilized by service providers. Infrastructure and operations computing devices 190 can provide current information about the status of infrastructure and associated operations/management.

In some implementations, the system 100 can include one or more vehicle provider computing devices 195. The vehicle provider computing device(s) 195 can be associated with one or more vehicle providers. A vehicle provider can be an entity (e.g., a first party entity, third party entity, etc.) that operates, owns, leases, controls, manufactures, etc. one or more vehicles. For example, a vehicle provider can include an operator, vendor, supplier, manufacturer, etc. of one or more aircraft. Each vehicle provider can be associated with respective vehicle provider computing device(s) 195. The vehicle provider computing device(s) 195 can be configured to manage the vehicles associated with that vehicle provider. This can include, for example, overseeing itineraries, accepting/rejecting transportation services, suggesting candidate vehicles, overseeing maintenance, controlling online/offline status, etc. A vehicle provider computing device 195 can communicate with the cloud services system 102 directly and/or indirectly. A vehicle associated with a vehicle provider can communicate directly with the cloud services system 102 and/or indirectly via the vehicle provider computing device(s) 195 (e.g., acting as an intermediary, etc.).

The vehicle providers' vehicles that are available for transportation services can include one or more types of vehicles. For example, the vehicle provider(s) can include a plurality of aerial vehicle providers, where each vehicle provider can provide a different type of aircraft (e.g., VTOL, helicopter, etc.) and/or a different model of aircraft. In some implementations, a vehicle provider can provide more than one type, version, model, etc. of aircraft available for the cloud services system 102 and/or the service entity. The different types of aircraft can include different shapes, sizes, capacities, capabilities, parameters, autonomy abilities (e.g., autonomous, semi-autonomous, manual, etc.), landing gear, hardware, etc. Although the following describes vehicle providers as aerial vehicle providers, this is provided as an example only and is not intended to be limiting. For example, vehicle providers can include providers of other types of vehicles such as ground-based vehicles (e.g., cars, bicycles, scooters, etc.) and/or other modes of transportation.

The cloud services system 102 and the vehicle provider computing device(s) 195 can communicate information to one another. The vehicle provider computing device(s) 195 can communicate various types of information to the cloud services system 102. For example, the vehicle provider computing device(s) 195 can provide data indicative of: status information (e.g., online/offline status, on-trip status, vehicle availability for transportation service, etc.), acceptance and/or rejection of a service (e.g., an aerial transportation service, etc.), maintenance information, vehicle parameters (e.g., weight capacity, noise signature, number of seats, set configuration, flight hours, charging/refueling parameters, hardware, temperature control parameters, operational restrictions, etc.), flight schedules, candidate vehicles, locations, updates of any such information, aerial facility information, etc. The cloud services system 102 can communicate various types of information to a vehicle provider device 195. For example, the cloud services system 102 can provide data indicative of: transportation services (e.g., services needed, specific vehicle requests, etc.), vehicle itineraries, status information (e.g., service in progress, etc.), vehicle parameter updates, payloads, locations, user/passenger information (e.g., anonymized and securely protected, etc.), air traffic information, environmental data (e.g., expected wind speeds, weather information, etc.), and/or other types of information.

The service entity associated with the cloud services system 102 can utilize vehicles associated with various parties. In some implementations, the service entity can also be a vehicle provider (e.g., a first party entity, etc.). For example, the service entity can utilize vehicles (e.g., ground-based vehicles, aircraft, etc.) within the service entity's fleet that are online with the transportation platform, etc. Additionally, or alternatively, the service entity can utilize vehicles provided by a vehicle provider from the vehicle provider's fleet. A fleet can include one or a plurality of vehicles. A vehicle provider can make one or more of the vehicles in its fleet available to the service entity/cloud services system 102. For example, the vehicle provider computing device(s) 195 and/or a service provider computing device of a vehicle can log into a transportation platform, provide data indicating a vehicle is available, facilitate the vehicle being actively engaged with the transportation platform, and/or otherwise inform a service entity of a vehicle's availability. In some implementations, a vehicle provider computing device 195 can provide data indicative of vehicles that are not online with the service entity and that could or may become available.

In addition, or alternatively, the facility computing device(s) 152 can provide current information (e.g., facility data 155) about an aerial transport facility. A facility computing device 152, for example, can be associated with an aerial transport facility. The facility computing device 152 can monitor current information of the aerial transport facility and provide the current information to the world state system 126. In some implementations, an aerial transport facility can be associated by a service entity (e.g., leased, owned, etc. by a transportation network provider, etc.). In some implementations, the facility computing devices 152 can be included in the cloud services system 102 and/or one or more functions/systems of the cloud services computing system 102 can be included in the facility computing system 152. In some implementations, the aerial transport facility can be associated with a vehicle provider (e.g., leased, owned, etc. by a vehicle provider with a fleet of aircraft, etc.). In some implementations, the facility computing devices 152 can be included in the vehicle provider computing devices 195 and/or one or more functions/systems of the vehicle provider computing devices 195 can be included in the facility computing system 152.

In addition, in some implementations, the facility computing device(s) 152 can be associated one or more climate control infrastructure(s) 192. For example, an aerial facility can include a climate control infrastructure. In such a case, the facility data 155 can include current information associated with the climate control intrastate. Such information can be provided to the world state system 126 by the facility computing device(s) 152 and/or the climate control infrastructure(s) 192.

In some implementations, the aerial computing device(s) 142 can provide current information (e.g., vehicle data 145) about an aerial vehicle. The aerial computing device 142, for example, can be associated with an aerial vehicle with one or more components (e.g., a power source, a cabin, hardware, etc.) and/or one or more vehicle sensors. The aerial computing device(s) 142 can monitor current information, for example, via the one or more vehicle sensors and provide the current information to the world state system 126. For example, the current information can include climate information such as one or more thermal parameters.

The forecasting system 128 can generate predictions of the demand and supply for transportation services at or between various locations over time. The forecasting system 128 can also generate or supply weather forecasts. The forecasts made by the system 128 can be generated based on historical data and/or through modeling of supply and demand. In some instances, the forecasting system 128 can be referred to as an RMR system, where RMR refers to “routing, matching, and recharging.” The RMR system can be able to simulate the behavior of a full day of activity across multiple ride share networks.

The optimization/planning system 130 can generate transportation plans for various transportation assets and/or can generate itineraries for passengers. For example, the optimization/planning system 130 can perform flight planning. As another example, optimization/planning system 130 can plan or manage/optimize itineraries which include interactions between passengers and service providers across multiple modes of transportation.

The matching and fulfillment system 132 can match a passenger with a service provider for each of the different transportation modalities. For example, each respective matching system 134 can communicate with the corresponding service provider computing devices 150, 160, 170 via one or more APIs or connections. Each matching system 134 can communicate trajectories and/or assignments to the corresponding service providers. Thus, the matching and fulfillment system 132 can perform or handle assignment of ground transportation, flight trajectories, take-off/landing, etc.

For example, the one or more aerial computing devices 142 can include a service provider device 150, 160, 170 associated with an aircraft. The aerial computing devices 142 can include, for instance, a user computing device associated with a pilot of the aircraft, a vehicle computing device associated with the aircraft, etc. For instance, the aircraft can include an autonomous aircraft with a vehicle computing system (e.g., aerial computing device 142) configured to facilitate the movement of the aircraft.

The monitoring and mitigation system 136 can perform monitoring of user itineraries and can perform mitigation when an itinerary is subject to significant delay (e.g., one of the legs fails to succeed). Thus, the monitoring and mitigation system 136 can perform situation awareness, advisories, adjustments and the like. The monitoring and mitigation system 136 can trigger alerts and actions sent to the devices 140, 142, 150, 152, 160, 170, 190, and 192. For example, passengers, service providers, aircraft, and/or operations personnel can be alerted when a certain transportation plan has been modified and can be provided with an updated plan/course of action. Thus, the monitoring and mitigation system 136 can have additional control over the movement of aircraft, ground vehicles, pilots, and passengers.

In some implementations, the cloud services system 102 can also store or include one or more machine-learned models. For example, the models can be or can otherwise include various machine-learned models such as support vector machines, neural networks (e.g., deep neural networks), decision-tree based models (e.g., random forests), or other multi-layer non-linear models. Example neural networks include feed-forward neural networks, recurrent neural networks (e.g., long short-term memory recurrent neural networks), convolutional neural networks, or other forms of neural networks.

In some instances, the service provider computing devices 150, 160, 170 can be associated with autonomous vehicles (e.g., autonomous VTOL aircraft). Thus, the service provider computing devices 150, 160, 170 can provide communication between the cloud services system 102 and an autonomy stack of the autonomous vehicle which autonomously controls motion of the autonomous vehicles.

The infrastructure and operations computing devices 190 can be any form of computing device used by or at the infrastructure or operations personnel including, for example, devices configured to perform passenger security checks, luggage check in/out, re-charging/re-fueling, safety briefings, vehicle check in/out, and/or the like.

The network(s) 180 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 180 can be accomplished, for instance, via a network interface using any type of protocol, protection scheme, encoding, format, packaging, etc.

The system 100 can be configured to facilitate the climate control for an aircraft. For example, the aerial computing devices 142, the facility computing devices 152, and/or the climate control infrastructure 192 can be configured to perform one or more climate control operations described herein, for example, as described below with reference to the remaining FIGS to determine and implement climate control operations for an aircraft within a landing area of aerial transport facility to facilitate a multi-modal transportation service.

For example, the cloud services system 102 can be configured to manage, coordinate, and dynamically adjust a multi-modal transportation service via a transportation platform. The multi-modal transportation service can include a plurality of transportation legs, one of which (e.g., a second transportation leg) can include an aerial transport of a user. For example, the cloud services system 102 can obtain a request for a transportation service (e.g., from a rider computing device 140). The request for the transportation service can include at least a request for an aerial transport of a user of the transportation platform. The cloud services system 102 can obtain the request from a user device (e.g., a rider computing device 140) associated with the user of the transportation platform.

The request for the transportation service can include an origin location and a destination location. In some instances, unless specified otherwise, the origin of the transportation service can be assumed to be a current location of the user (e.g., as indicated by location data such as GPS data received from a rider computing device 140 and/or as input by the user). A user can also supply a desired destination (e.g., by typing the destination into a text field which may, for example, provide suggested completed entries while the user types).

A multi-modal transportation itinerary from the origin location to the destination location can be generated based on the request for the transportation service. The multi-modal transportation itinerary can include two or more transportation legs (e.g., a first transportation leg, a second transportation leg, a third transportation leg, etc.) between the origin location and the destination location specified in the request. The two or more transportation legs can include travel via two or more different transportation modalities such as, for example: cars, motorcycles, light electric vehicles (e.g., electric bicycles or scooters), buses, trains, aircraft (e.g., airplanes), watercraft, walking, and/or other transportation modalities. Example aircrafts can also include helicopters and other vertical take-off and landing aircraft (VTOL) such as electric vertical take-off and landing aircraft (eVTOL). The vehicles can include non-autonomous, semi-autonomous, and/or fully-autonomous vehicles.

The cloud services system 102 can facilitate the ability of a user to receive transportation on one or more of the transportation legs included in the multi-modal transportation itinerary. As an example, the cloud services system 102 can interact with a plurality of devices (e.g., one or more service provider devices 150, 160, 170, one or more facility computing device 152, one or more aerial computing devices 142, one or more climate control infrastructures 192, one or more infrastructure computing devices 190, one or more vehicle provider computing devices 195, etc.) to match the user with one or more transportation service providers for each transportation leg of the multi-modal transportation itinerary. For example, the cloud services system 102 can book or otherwise reserve a seat in, space on, or usage of one or more of the transportation modalities for the user. For example, the request for a transportation service can include at least an aerial transport of the user. In response, the cloud services system 102 can determine an aerial service provider to provide the aerial transport for the user (e.g., book a seat on an aircraft of the aerial service provider).

For example, in response to a user's request, the cloud services system 102 can utilize the one or more algorithms/machine-learned models to generate a multi-modal transportation itinerary for the user. As an example, in some implementations, the cloud services system 102 can sequentially analyze and identify potential transportation legs for each different available transportation modality. For example, a most critical, challenging, and/or supply-constrained transportation leg can be identified first and then the remainder of the multi-modal transportation itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first). By way of example, the cloud services system 102 can assign the user to an aircraft for the middle leg of a three-leg multi-modal itinerary and, then, book a human-driven or autonomous ground-based vehicle for a first leg of the multi-modal itinerary to take the user(s) from an origin location to a first aerial transport facility (e.g., to board the aircraft such as, for example, at an origin facility). At a later time (e.g., while the user(s) are in flight), the cloud services system 102 can book another human-driven or autonomous ground-based vehicle to take the user(s) from a second aerial transport facility (e.g., a destination facility) to the specified destination location(s).

The vehicles to be utilized for a particular multiple-modal transportation service can be determined in a variety of manners. The cloud services system 102 (and the associated service entity) may have varying levels of control over the vehicle(s) that perform its services. For example, a vehicle provider may make one or more vehicles available to the service entity. The service entity may be able to determine which vehicles are to perform which legs of a transportation without input from the vehicle provider. Thus, the service entity may have full control of the vehicles online with the platform.

In some implementations, the service entity may determine transportation service assignments for vehicles of the service entity, while a vehicle provider may be able to determine (e.g., accept, reject, etc.) transportation service assignments for its vehicles. For example, the cloud services system 102 can provide data indicative of a flight leg, itinerary, etc. to one or more vehicle provider computing devices 195. The data can indicate a request for a specific vehicle or a request for any available vehicle within the vehicle provider's available fleet to perform the transportation service (e.g., flight transportation between two vertiports, etc.). In some implementations, the data may include certain parameters (e.g., weight capacity, number of seats, noise parameters, etc.) needed and/or preferred by the service entity, user, etc. The vehicle provider computing device 195 can process this data and determine whether a specifically requested vehicle and/or another vehicle associated with the vehicle provider will provide the requested service (e.g., perform a flight for the second leg of a multi-model transportation service). The vehicle provider computing device 195 can communicate data indicative of the acceptance or rejection to the cloud services system 102. In some implementations, data indicative of the requested transportation service can be communicated to a service provider computing device 150, 160, 160 associated with a vehicle of a vehicle provider's fleet (e.g., an aircraft, etc.) and the service provider can accept or reject the service (e.g., the flight transportation, etc.).

In some implementations, one or more vehicle provider computing device(s) 195 can communicate data indicative of a plurality of candidate vehicles that could provide the requested service (e.g., perform an aerial transportation service for a flight leg). The cloud services system 102 can select from among the plurality of candidate vehicles and communicate data indicative of the selected candidate vehicle to the vehicle provider computing device(s) 195.

The cloud services system 102 can determine which vehicles are to perform which transportations legs in an on-demand manner or based at least in part on a schedule. For example, cloud services system 102 can initially generate a flight itinerary in response to receiving a first request. In some implementations, the cloud services system 102 can have a pre-determined flight schedule and offer aerial transport (e.g., for multi-modal transportation services, etc.) in the event that a user's time constraints and locations can be met with the pre-determined flight schedule.

In some implementations, the vehicle provider may provide initial input regarding vehicle scheduling. For example, the vehicle provider computing device 195 can communicate data indicative of a flight schedule for one or more aircrafts between various aerial transport facilities. The vehicle provider 195 can communicate initial seat availability, as well as updates throughout an operational time period (e.g., throughout a day, etc.), to the cloud services system 102. The cloud services system 102 can utilize this flight schedule to determine itineraries for users and/or vehicles of the transportation service. For example, the cloud services system 102 can use the flight schedule to determine whether to offer a multi-modal transportation service with an aerial leg to a user and/or to generate itineraries with aerial legs based on the flight schedule. In some implementations, the flight schedule can be an initial flight schedule for an operational time period. For example, the vehicle provider computing device(s) 195 can provide data indicative of the initial flights for the available vehicles at the beginning of a day. The cloud services system 102 can utilize this data to determine multi-modal transportation services at the beginning of the day. Thereafter, the cloud services system 102 can determine the flight itineraries in an on-demand manner to meet user/passenger demand throughout the operational time period.

Additionally, or alternatively, the cloud services system 102 can communicate data indicative of a schedule (e.g., initial, for full operational period, etc.) to the vehicle provider computing device(s) 195. The vehicle provider computing device(s) 195 can process the schedule and communicate data indicative of which vehicles (e.g., aircraft, etc.) are available for which services (e.g., flight legs, etc.).

In some implementations, the cloud services system 102 can communicate data indicative of a transportation service (e.g., one or more flight legs, schedules, etc.) to a plurality of vehicle provider computing device(s) 195. One or more of the vehicle provider computing device(s) 195 can process the data and communicate data indicative of vehicle(s) (e.g., aircraft, etc.) that are available to fulfill the transportation service (e.g., perform aerial transportation for one or more leg(s), etc.) to the cloud services system 102. In some implementations, the vehicle provider computing device(s) 195 can provide information indicative of vehicle parameters, costs/fees, etc. The cloud services system 102 can be configured to analyze the responses from the plurality of vehicle provider computing devices 195 to determine a service provider. For example, the cloud services system 102 can utilize rules, models, algorithms, etc. that weigh the various vehicle parameters to select an aircraft for a user to ensure that the user's estimated arrival times are not violated, to minimize costs, etc.

In some implementations, a vehicle provider and a service entity can coordinate, manage, etc. different portions of a multi-modal transportation offering. By way of example, the service entity (e.g., the cloud services system 102, etc.) can receive a request for a transportation service. The cloud services system 102 associated with the service entity can obtain data indicative of available aircraft, aerial transport facilities (e.g., locations, availability, facilities with available aircraft, etc.), and/or other information to determine whether an aerial transportation service can be offered to a user in order to help transport the user to a requested destination. This data can be provided via one or more vehicle provider computing devices 195. The cloud services system 102 can determine whether to offer a multi-modal transportation service to a user (including aerial transport) based at least in part on this data. The cloud services system 102 can match and coordinate the user's ground transportation from an origin to a first aerial transport facility, the vehicle provider computing system 195 can match and coordinate the user's aerial transportation from the first aerial transport facility to a second aerial transport facility, and the cloud services system 102 can match and coordinate the user's ground transportation from the second aerial transport facility to a destination. The cloud services system 102 and the vehicle provider computing system 195 can communicate to provide information to the user via one or more applications running on a rider device 140. In another example, the vehicle provider computing system 195 can obtain data indicative of a request for transportation services. The vehicle provider computing system 195 can communicate with the cloud services system 102 to append ground transportation to an aerial transportation leg provided by the vehicle provider, as similarly described.

The vehicle provider computing device(s) 195 and/or the cloud services system 102 can communicate data indicative of the transportation service (e.g., flight itinerary data, etc.) to a service provider computing device 150, 160, 170, 195 associated with a vehicle. For example, a vehicle provider device 195 or the cloud services system 102 can communicate data indicative of a flight (e.g., times, locations, users, payload, etc.) to a computing device onboard an aircraft and/or a device of a pilot of the aircraft.

In this manner, the cloud services system 102 (and/or the other computing devices of system 100) can generate a multi-modal transportation itinerary for facilitating the aerial transportation of the multi-modal transportation service. The multi-modal transportation itinerary can include at least a first transportation leg, a second transportation leg, and a third transportation leg. An aerial service provider, for example, can be associated with the second transportation leg to provide the aerial transport to the user during the second transportation leg from a first aerial transport facility to a second aerial transport facility.

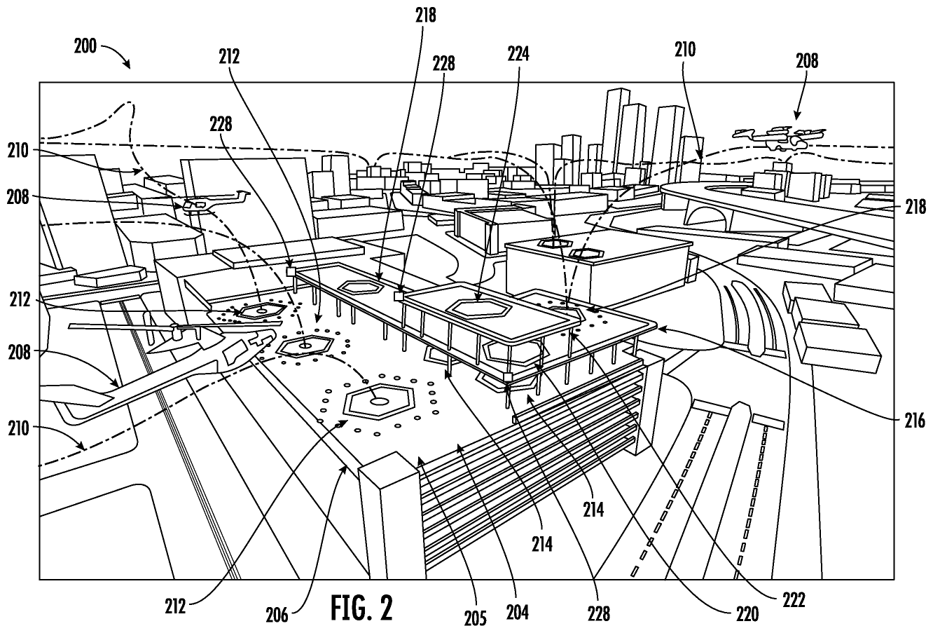

FIG. 2 illustrates an example embodiment of an aerial transport facility 200 in an urban environment according to aspects of the present disclosure. One or more portions of the aerial transport facility 200 can be elevated such as, for example, located on a roof 204 of a structure 206, such as a parking garage. In some implementations, one or more portions of the aerial transport facility 200 can be located at ground level. The aerial transport facility 200 can provide landing and/or take-off locations for one or more aircraft 208 (e.g., vertical take-off and landing (VTOL) aircraft) of a multi-modal transportation service.

The aerial transport facility 202 can include a lower level 205, which can include the roof 204 of the structure 206 and/or a platform supported on the roof 204 of the structure 206. The lower level 205 can include a lower landing area including one or more landing pads 212 and a storage area that includes one or more lower storage locations 214. The aerial transport facility 202 can include an upper level 216 that is supported over at least a portion of the lower level 205. For example, the upper level 216 can be located over one or more of the lower storage locations 214. The upper level 216 can have one or more upper landing pads 218 within an upper landing area and one or more storage locations 220 within an upper storage area. An additional level 222 can be arranged over the storage location(s) 220 of the upper level 216. The additional level 222 can include an emergency landing pad 224 within an emergency landing area 226. However, it should be understood that, in some embodiments, the aerial transport facility 202 can be free of any additional levels above the upper level 216.

A system such as, for example, the system 100, the cloud services system 102, the facility computing devices 152, etc. as described with reference to FIG. 1, can be configured to control, route, monitor, and/or communicate with aircraft in the vicinity of the aerial transport facility 202, for example as described herein. The computing system can be configured to determine or aid in determining respective routes 210 for the aircraft 208 for landing on the aerial transport facility 202 and/or taking-off from the aerial transport facility 202. The computing system can determine a respective landing pad on which the aircraft 208 can land.

In some embodiments, one or more sensors 228 can be configured to detect a location of the aircraft 208 relative to the landing pad (e.g., during approach, landing, taxing, or storage). For example, a portion of the computing system (e.g., facility computing devices 152 located at the aerial transport facility 200) can be operatively connected with the sensor(s) 228 and configured to detect the presence and/or location of aircraft 208 within the landing areas, within the storage areas, during approach and/or during takeoff. The sensors 228 can be any suitable type of sensor including optical, infrared, heat, radar, LIDAR, pressure, capacitive, inductive, etc. As illustrated, the sensors 228 can be mounted on the upper level 216 or additional level 222. However, in other embodiments, the sensors 228 can be mounted within the lower level 205 and/or upper level 216, for example as capacitive sensors to detect the presence/location of the aircraft 208 in the lower level 205 and/or upper level.

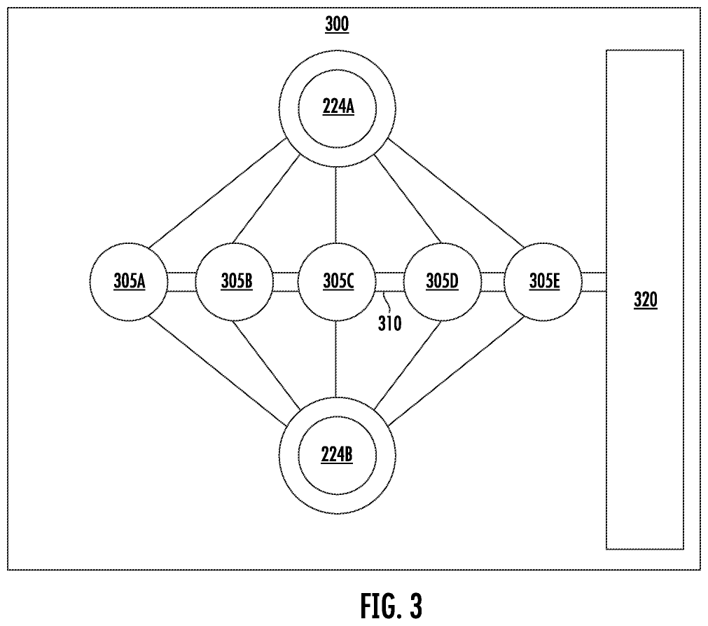

FIG. 3 depicts an example aerial transport facility landing area 300 according to example implementations of the present disclosure. An aerial transport facility can include a landing area 300 defined by one or more edges (e.g., a boundary of a roof, parking garage, etc.). The landing area 300 of an aerial transport facility can be located on a roof of a structure, such as a parking garage and/or at ground level and can provide landing and take-off locations 224A-B, and parking, charging and/or cooling locations 305A-E for one or more aircraft of an aerial service provider. For example, the landing area 300 can include one or more landing pads 224A-B where an aerial vehicle can land at and/or depart from the aerial transport facility, one or more parking locations 305A-E where an aerial vehicle can park in between aerial transport services, one or more charging locations 305A-E where an aerial vehicle can charge (and/or refuel) before departure, and/or one or more cooling locations 305A-E where one or more components of an aerial vehicle can be cooled down. In some implementations, one or more parking location(s) 305A-E can include one or more charging and/or cooling locations. For instance, a parking location, cooling location, and a charging location can include the same location (e.g., 305A-E) within a landing area 300 of an aerial transport facility.

A computing system (e.g., an operations computing system, aerial transport facility computing system, vehicle provider computing system/devices, etc.) can be configured to control, route, monitor, and/or communicate with aircraft in the vicinity of the aerial transport facility. The computing system can be configured to determine or aid in determining respective routes for the aircraft for landing at the landing area 300 of the aerial transport facility and/or taking-off from the landing area 300 of the aircraft transport facility. In addition, or alternatively, the computing system can determine respective landing pad locations 224A-B on which the aircraft can land and/or depart from and/or one or more parking, charging, and/or cooling locations 305A-E to which the aircraft can travel once landed at the landing area 300. The computing system, for example, can determine a location for an aircraft to receive one or more climate control operations from a climate infrastructure 320 of the aerial transport facility. The climate control operation(s), for example, can be implemented to cool one or more components (e.g., cabin, hardware, power source, etc.) of an aerial vehicle before the aerial vehicle is scheduled to depart the transportation facility (e.g., take-off from the landing area 300).

For example, an aerial transport facility of the present disclosure can include a climate control infrastructure 320. The climate control infrastructure 320 can include one or more climate control computing systems on the landing area 300 of the aerial transport facility. For example, the climate control infrastructure can include a central climate control system 320 and/or a plurality of climate control devices. The central climate control system 320, for example, can include a central cooling distribution system (e.g., chilling plant, heating, ventilation, and air conditioning (HVAC) system, glycol air cooler system, etc.) configured to distribute thermal material (e.g., air, liquid, liquid cooled air, antifreeze, etc.) to one or more locations 305A-E (e.g., cooling locations), aerial vehicles, and/or climate control device(s) on the landing area 300. In this regard, the central climate control system 320 can include one or more heat exchangers, motors (e.g., blower motors, etc.), combustion chambers, coil (condenser coils, evaporator coils, etc.), compressors, thermostats, and/or any other mechanism for facilitating the climate control operations described herein. In some implementations, the central climate control system 320 can be configured to service each of the one or more parking locations, charging locations, and/or cooling locations 305A-E of the landing area 300. For instance, the central climate control system 320 can branch out 310 (e.g., via one or more cables, pipes, etc.) to each location 305A-E and/or aerial vehicle of the landing area 300.

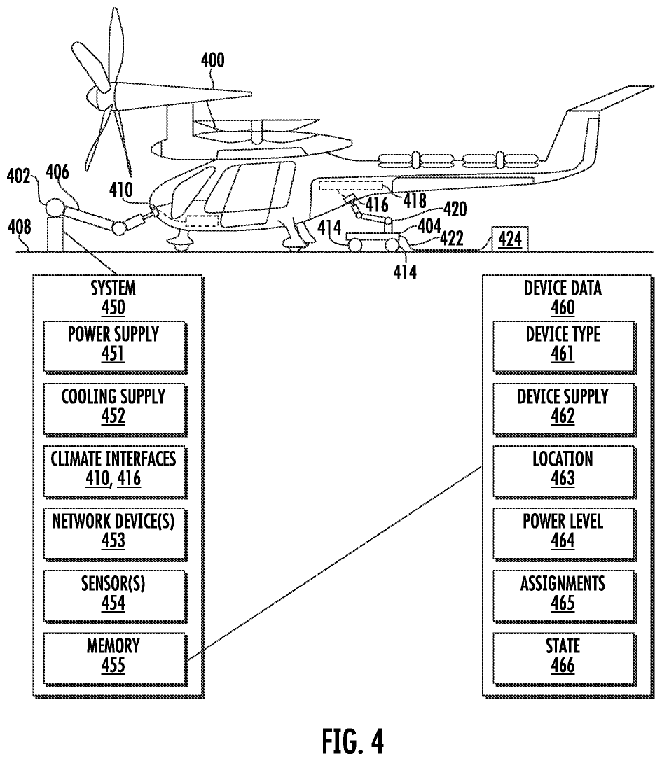

The central climate control system 320 can interact with a plurality of climate control devices to implement one or more climate control operations. For example, FIG. 4 depicts example climate control devices according to example implementations of the present disclosure. The plurality of climate control devices can include a fleet of robotic climate control devices 402, 404 configured to service (e.g., by performing one or more climate control operations) an aerial vehicle 400. The central climate control system, for instance, can be configured to supply power, cooling materials, etc. to the fleet of robotic climate control devices 402, 404 to enable the devices to service the vehicle 400. The fleet of robotic climate control devices 402, 404 can include a variety of robotic devices including, for example, one or more stationary climate control device(s) 402 and/or one or more mobile climate control device(s) 404.

As illustrated by FIG. 4, an aerial vehicle 400 can be cooled by a stationary climate control device 402 and/or a mobile climate control device. The stationary climate control device(s) 402 can include an interfacing component 406 (e.g., robotic arm and/or one or more other components capable of interfacing with component(s) of an aerial vehicle) having an end 407 that is stationary with respect to a surface 408 on which the aerial vehicle 400 is positioned (e.g., a landing area surface, parking surface, etc.). For example, the interfacing component 406 can be coupled (e.g., mounted, tethered, etc.) to a surface 408 on which the aircraft 400 is positioned (e.g., a landing surface, parking surface, etc.). Alternatively, the interfacing component 406 can be coupled to a structure that is stationary with respect to the surface on which the aircraft 400 is positioned (e.g., coupled to a roof, covering, and/or support thereof). In some implementations, for example, the interfacing component 406 can be mounted to a stationary charging device mounted to the surface of the landing area.

The mobile climate control device 404 can be mobile (e.g., on tracks or wheels 414). The mobile climate control device 404 can be configured to travel to the aircraft 400 (e.g., after the aircraft 400 lands). For example, the mobile climate control device 404 can be configured to autonomously navigate the landing area of an aerial transport facility to the aircraft 400. In some implementations, the mobile climate control device 404 can include an interfacing component 420 mounted to a mobile surface (e.g., a battery powered platform with one or more wheels 414). In some implementations, for example, the interfacing component 420 can be mounted to a mobile charging device. The mobile climate control device 404 can travel (e.g., via the mobile platform, mobile charging device, etc.) to an aerial vehicle 400 to service component(s) of the aerial vehicle 404.

The interfacing component(s) 406, 420 of the climate control device(s) 402, 404 can be configured to operatively interface with one or more aerial components (e.g., a cabin, power source, hardware, etc.) of an aerial vehicle 400 to facilitate one or more climate control operations (e.g., cool down a power source, cabin, hardware, etc.). For example, the interface component(s) 406, 420 can include at least one climate control interface 410, 416. The climate control interface(s) 410, 416 can include one or more power source interface(s) 416 (e.g., configured to interface with a power source 418 of an aerial vehicle 400), one or more cabin interface(s) 410 (e.g., a blower configured to interface with a cabin of an aerial vehicle 400 (e.g., by forcing cool air into a cabin)), and/or a one or more of hardware interface(s) (e.g., configured to interface with hardware (e.g., dashboards, seats, railings) within the cabin of an aerial vehicle 400). In this manner, the central climate control system (e.g., system 320 of FIG. 3) can interface with a plurality of aircraft components through the climate control device(s) 402, 404 (e.g., by supplying the fleet of climate control device(s) 402, 404) at one or more locations of the landing area. For instance, the climate control device(s) 402, 404 can include at least one stationary 402 and/or mobile climate control device 404 at each landing pad, parking location, cooling location, charging location, and/or any other location of the landing area.

The plurality of climate control device(s) can include an internal system 450 including a power supply 451 (e.g., a battery, power interface, etc.), cooling supply 452 (e.g., cool water, air, gas, etc.), one or more climate control interface(s) 410, 416 (e.g., of the interface component(s) 406, 420), network devices 453 (e.g., communication interfaces such as one or more radio frequency devices, etc.), one or more sensors 454 (e.g., location sensors (e.g., GPS), cameras, etc.), one or more memories 455, etc. For example, one or more of the climate control device(s) 402, 404 (e.g., the stationary climate control devices 404) can include a power interface 422 (e.g., cable, etc.) connected to a central power supply 424 (e.g., of the central climate control system 320). In addition, or alternatively, one or more of the climate control device(s) 402, 404 (e.g., the mobile climate control devices 402) can include one or more mobile power sources. The mobile power source(s) for instance can include one or more batteries (e.g., thermal batteries, lithium ion batteries, etc.) capable of receiving and storing a charge. For instance, the mobile power source(s) can include a power interface 422 configured to connect to the central power supply 424 to resupply energy stored by the mobile power supply 451.

The cooling supply 452 can include cooling material(s) usable by the one or more climate control interfaces 410, 416 of the plurality of climate control device(s) 402, 404 to service component(s) of the aerial vehicle 400. Cooling material(s), for instance, can include air (cool air, compressed air, one or more gasses), liquid (cold water, liquid nitrogen, etc.), and/or one or more cooling solids (e.g., ice, coils, etc.) configured to lower the temperature of one or more aircraft components. As an example, a cooling material can include one or more metal coils configured to retain low temperatures. As another example, a cooling material can include cold water previously chilled, for example, by the central climate control system 320.

The cooling materials can include one or more exhaustive resources. For instance, a metal coil and/or previously chilled water can retain a low temperature for a limited time period. In such a case, the central climate control system 320 can include a central cooling supply. A respective climate control device 402, 404 can interact with the central climate control system 320 to refill (and/or rechill) the cooling material of the respective climate control device's cooling supply 452. In some implementations, each device of the plurality of climate control devices 402, 404 can include a cooling supply 452 with a threshold level of cooling material sufficient to cool multiple vehicles throughout a travel day.

The cooling material(s) of a climate control device(s) cooling supply 452 can be applied by climate control interface(s) 410, 416 to a respective aerial component to modify the temperature of the aerial component. For example, a respective climate control device 402, 404 can utilize the cooling material and one or more respective climate control interfaces 410, 416 to cool one or more aerial components of a respective aerial vehicle 400. By way of example, a cabin climate control interface 410 can include a heat exchanger with a fan. The fan can be configured to blow air over a cooling material (e.g., cold water, liquid nitrogen, etc.) to funnel cool air into a cabin of the aerial vehicle 400. As another example, a power source climate control interface 416 can include a rod, pipe, etc. configured to be inserted through and/or otherwise around power source 418 of the aerial vehicle 400. The power source climate control interface 416 can be previously cooled by one more cooling materials before it is placed near the power source 418. In addition, or alternatively, the power source climate control interface 416 can include one or more pumps configured to circulate a cooling material within the power source climate control interface 416 (e.g., a rod, pipe, etc.) before, after, and/or while the power source climate control interface 416 is placed near the power source. A hardware climate control interface can include any of the above mentioned interfaces. For example, a hardware climate control interface can include a heat exchanger fan, a rod, pipe, and/or any other cooling mechanism. In this manner, a climate control device 402, 404 can interact with a central cooling system 320 (e.g., to obtain cooling material and/or power) to cool one or more components of an aerial vehicle 400.

In some implementations, aerial vehicle 400 can include a respective power source 418 of a plurality of different power sources. For instance, an aerial vehicle 400 can include an electric aerial vehicle powered by one or more batteries (e.g., thermal batteries, lithium batteries, etc.). One or more different electric aerial vehicles can include one or more different battery types. Each battery type can be configured to interface with a different power source climate control interface. In such a case, the fleet of climate control devices 402, 404 can include a plurality of different power source climate control interfaces, each configured to interface with and/or cool a respective battery type (e.g., grouped by manufacturer, cooling process, etc.). For instance, each of the plurality of climate control devices 402, 404 can include one or more of the different power source climate control interfaces. In some implementations, each device can include a power source climate control interface for each of the different power source types.

Each device of the plurality of climate control device(s) 402, 404 can be associated with device data 460. The device data 460 can be indicative of one or more device parameters such as, for example, a device type 461, device supply 462, device location 463 (e.g., dynamic location coordinates for mobile device(s) 404, static coordinates for static device(s) 402, etc.), device power level 464, assignment data 465, device state data 466, and/or any other information to facilitate climate control operations for aerial vehicles 400. The device supply 462, for example, can be indicative of a current amount and type of cooling material stored (e.g., in cooling supply 452) and/or otherwise accessible to a respective device 402, 404. The power level 464 can be indicative of a current amount of power accessible (e.g., by power supply 451) to the respective device 402, 404. In addition, in some implementations, the power level 464 can include power usage data that identifies a level of power currently used by a respective device 402, 404 (e.g., to service a component of an aerial vehicle 400), a level of power expected to be used by the respective device 402, 404 (e.g., to implemented a climate control operation for aerial component(s)), and/or a level of power previously used (e.g., power used during the course of implementing one or more previous climate control operations).

The device type 461 can be indicative of one or more interfacing capabilities of a respective device 402, 404. For example, a device type 461 can indicate one or more aerial components of one or more aerial vehicle(s) that a respective device 402, 404 is capable of servicing (e.g., cooling). For instance, the device type 461 can indicate one or more climate control interfaces 401, 416 of a respective climate control device 402, 404. By way of example, a cabin device type can be capable of servicing cabin components of an aerial vehicle 400. To do so, a climate control device 402 associated with a cabin device type can include one or more cabin climate control interfaces 410. As another example, a respective power source device type can be capable of servicing a respective power source 418 of an aerial vehicle 400. To do so, a climate control device 404 associated with the respective power source device type can include one or more power source climate control interfaces 416 configured to interface with the respective power source type 418 of the aerial vehicle 400.

The device state data 466 can include a current state of a respective climate control device 402, 404. A current state can be indicative of a busy state indicating that the device 402, 404 is carrying out an assignment, a low resource state indicating that the device 402, 404 is associated with a low power level and/or supply level, etc. The assignment data 465 can be indicative of one or more climate control assignments for a respective climate control device 402, 404. For example, the assignment data 465 can include one or more control instructions to carry out one or more portions of a climate control configuration to service one or more components of an aerial vehicle 400. As described in more detail with reference to the climate control configuration, the assignment data 465 can include a respective aerial component, a time, a desired temperature, and/or any other information associated with coordinating climate control.

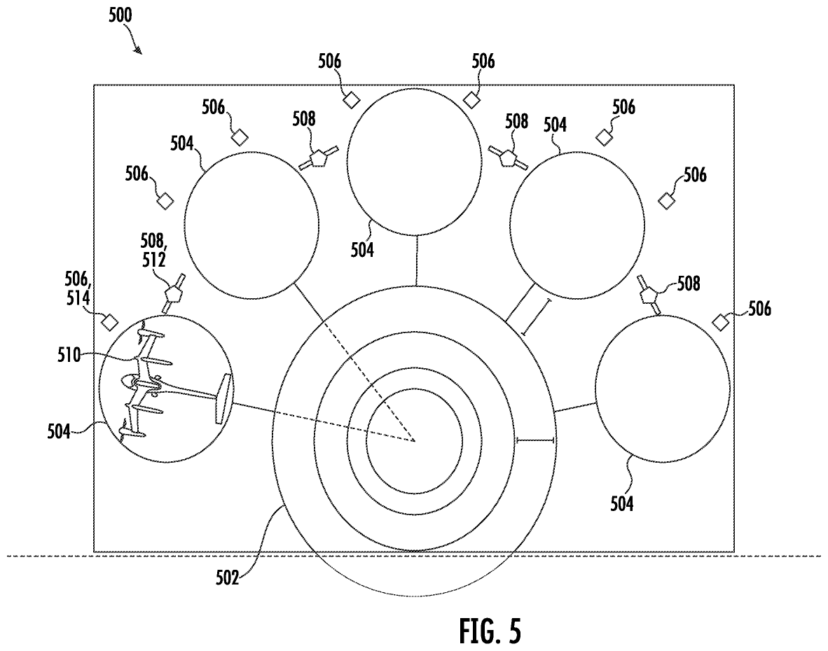

FIG. 5 depicts an example an example aerial transport facility 500 with climate control devices according to example implementations of the present disclosure. In some implementations, a fleet of robotic charging devices can be configured to service multiple aerial vehicles, for example shortly after the aerial vehicles land at the aerial transport facility 500. The aerial transport facility 500 can include a landing pad 502, one or more parking/cooling area(s) 504 and/or one or more climate control devices such as climate control devices 506, 508. For example, the aerial transport facility 500 can include one or more stationary climate control devices 506 and/or one or more mobile climate control devices 508. A variety of robotic charging devices 506, 508 can be employed (e.g., at an aerial transport facility 500) within the scope of the present disclosure. As discussed herein, a respective climate control device 512, 514 can be determined and selected for assignment to an aerial vehicle 510. For example, the respective climate control device(s) 512, 514 can be matched to the aerial vehicle 510 based on a climate control configuration.

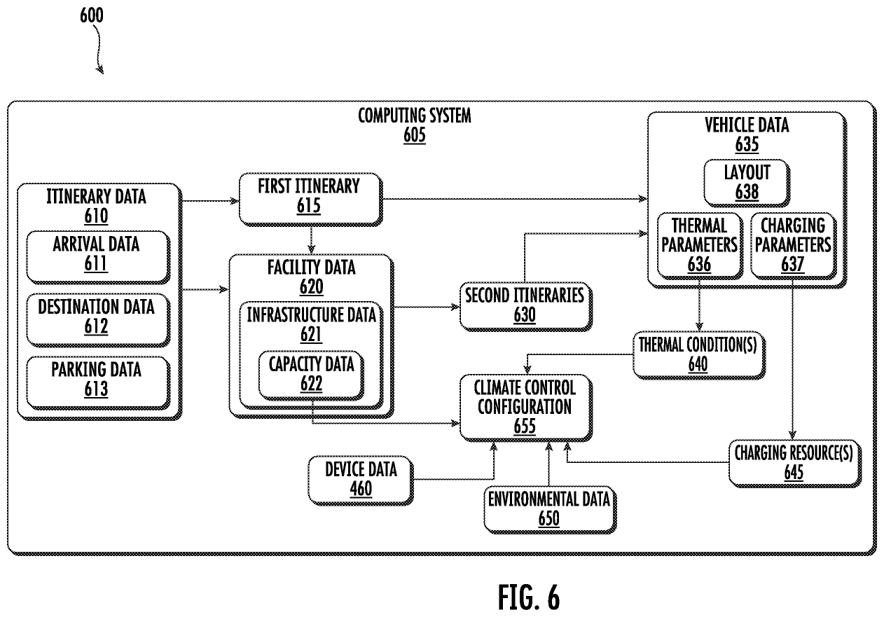

By way of example, FIG. 6 depicts an example data flow diagram 600 for determining a climate control configuration according to example implementations of the present disclosure. FIG. 6 depicts a computing system 605 that can interact with the climate control infrastructure (e.g., central climate control system, fleet of climate control devices, etc.) of an aerial transport facility to coordinate the climate control of a plurality of aerial vehicles at or scheduled to be at the aerial transport facility. The computing system 605 can include any computing system and/or device described herein, for example, with reference to any of the FIGS. By way of example, the computing system 605 can include system 100, cloud services system 102, aerial computing device(s) 142, climate control infrastructure(s) 192, facility computing devices 152, and/or any other computing system and/or device described herein.

The computing system 605 can obtain climate control related data. The climate control related data can include data associated with a multi-modal transportation service such as, for example, itinerary data 610, vehicle data 635 associated with one or more aerial vehicles (e.g., vehicle data 145 of vehicle device(s) 142), facility data 620 associated with an aerial transport facility (e.g., facility data 155 of facility device(s) 155), and/or any other data relevant to managing climate control for an aerial vehicle. For example, the computing system 605 can obtain data associated with a multi-modal transportation service. The data associated with the multi-modal transportation service can include itinerary data 610 indicative of one or more itineraries 615, 630 for one or more aerial vehicles. The one or more aerial vehicles, for example, can include a first vehicle for facilitating the multi-modal transportation service and/or one or more second vehicles associated with a common aerial transportation facility.

The one or more flight itineraries 615, 630 can include a flight itinerary for each of a plurality of aerial vehicles associated with a transportation service provider. Each flight itinerary can include one or more transports from one or more first aerial facilities to one or more second aerial facilities. Each transport, for instance, can include an origin facility, a departure time, an arrival facility, and/or an arrival time. In some implementations, the itinerary data 610 can include arrival data 611, destination data 612, and/or parking data for each of the one or more itineraries. The arrival data 611, for example, can include an arrival time and/or location for an aerial vehicle at an aerial facility, the destination data 612 can include a departure time and/or subsequent location from the aerial facility, and/or the parking data 613 can include a parking time at the aerial facility. For example, an itinerary with multiple transports can include an origin facility, a first departure time, a first destination facility, an arrival time, a second destination facility, and/or a second departure time. In such a case, the itinerary can indicate a parking time at the first destination facility between the arrival time and the second departure time.

The one or more itineraries can include a first itinerary 615 for the first aerial vehicle (e.g., for facilitating the multi-modal transportation service) and/or one or more second itineraries 630 for one or more second aerial vehicles. The first and/or second itineraries can be indicative of at least an aerial transport facility at which the first aerial vehicle and/or second aerial vehicle(s) are to be located (e.g., a destination facility). In addition, or alternatively, the first and/or second itineraries can be indicative of an arrival time of the first and/or second aerial vehicle(s) at the aerial transport facility, a departure time from the aerial transport facility, and/or one or more subsequent destination facilities (and/or one or more payloads (e.g., weight, number of passengers, etc.) for a transport to the subsequent destination facility). In addition, the first and/or second itineraries can include a parking time at the aerial transport facility (e.g., the time between the arrival time and the departure time). In this manner, the data indicative of a multi-modal transportation service (e.g., the itinerary data 610) can be indicative of an estimated time period for which the first and/or second aerial vehicles will be located at the aerial transport facility.

In addition, the computing system 605 can obtain vehicle data 635 for the first aerial vehicle and/or the one or more second aerial vehicles. For example, the computing system 605 can obtain vehicle data 635 associated with the one or more aerial vehicles. The vehicle data 635 can be indicative of vehicle layout 638, one or more thermal parameters 636, charging parameters 637 (e.g., a current charge level, etc.), and/or any other climate control information associated with the one or more aerial vehicles. A vehicle layout 638, for example, can be indicative of one or more components of a respective aerial vehicle. For instance, the vehicle layout 638 can identify dimensions of a vehicle cabin, a material (e.g., metal, plastic, leather, etc.) of one or more hardware components (e.g., a dashboard, seat, railing, etc.) within the vehicle cabin, and/or a power type (e.g., battery type, motor type, etc.) of a vehicle power source (e.g., battery, motor, etc.). By way of example, the one or more aerial vehicles can include one or more different batteries manufactured by one or more different manufacturers. The vehicle layout 638 can identify the type of power source of a respective aerial vehicle and a type of power source climate control interface that can interface with the type of power source. In some implementations, the vehicle layout 638 can be of a vehicle's thermal management. This can be indicative of the process, techniques, methods, etc. by which a vehicle manages its onboard temperature and the temperature of its components. For example, a vehicle can include an onboard thermal management system that cools the vehicle's cabin by transferring heat to the vehicle's batteries, using heat from the batteries for defogging, etc. This type of information can used to help determine climate control configuration 655, as further described herein.

The one or more thermal parameters 636 can include one or more temperatures associated with aircraft component(s) of an aerial vehicle. For example, an aerial vehicle can include a plurality of thermal sensors distributed throughout the vehicle (e.g., the cabin, hardware, power source, etc.). The plurality of thermal sensors can be configured to measure a temperature associated with the component(s) of the aerial vehicle. For instance, the aerial vehicle can include a cabin thermal sensor configured to measure the air temperature within the cabin of the aerial vehicle. As another example, the aerial vehicle can include cabin hardware thermal sensor(s) configured to measure the temperature of one or more hardware components within the cabin of the aerial vehicle. In addition, the aerial vehicle can include a power source thermal sensor configured to measure the temperature of one or more power sources of the aerial vehicle. In this manner, the aerial vehicle can collect temperature sensor data indicative of the temperature of the different component(s) of the aerial vehicle.

In some implementations, the one or more thermal parameters 636 can include a current temperature for the component(s) of the aerial vehicle. By way of example, the thermal parameter(s) 636 can include a current cabin temperature indicative of the current air temperature within the cabin of the aerial vehicle, a current hardware temperature indicative of the surface temperature of the one or more hardware components within the cabin of the aerial vehicle, a current power source temperature indicative of the internal temperature of the one or more power sources of the aerial vehicle, and/or the current temperature of any other component of the aerial vehicle.

In addition, or alternatively, the one or more thermal parameters 636 can include one or more threshold temperatures. The one or more threshold temperatures can be indicative of a maximum and/or minimum acceptable temperature for each component of the aerial vehicle. The one or more threshold temperatures can include a different threshold for each component(s) of the aerial vehicle. For example, a power source for an aerial vehicle can be associated with a battery temperature threshold indicative of the highest internal temperature allowable for safe operation of the battery. For instance, the highest internal temperature can include an internal temperature at which the battery can be at risk of overheating. As another example, a cabin for an aerial vehicle can be associated with a cabin temperature threshold indicative of the highest temperature at which passenger may begin to feel discomfort during a transportation service. The battery temperature threshold can include a temperature that is higher than the cabin temperature threshold. For instance, a passenger may begin to feel discomfort at a temperature lower than a temperature capable of causing a battery to overheat.

In some implementations, the computing system 605 can obtain facility data 620 associated with an aerial transport facility for providing the multi-modal transportation service. For example, the facility data 620 can be associated with the aerial transport facility at which the first aerial vehicle and/or second aerial vehicle(s) are to be located (e.g., a destination facility). For instance, the one or more aerial vehicles can utilize the aerial transport facility to provide the multi-modal transportation service. The facility data 620 can be indicative of a climate control infrastructure at the aerial transport facility. For example, the facility data 620 can include infrastructure data 621 indicative of the system data and/or device data for the central climate control system and/or the plurality of climate control devices of the climate control infrastructure at the aerial transport facility.

In addition, the facility data 620 can include capacity data 622. The capacity data 622 can identify one or more energy and/or climate control limits of the climate control infrastructure. For instance, the capacity data 622 can include an overall energy capacity indicative of the total power level (e.g., voltage, watts, etc.) accessible to the aerial transport facility (e.g., for use by the climate control infrastructure, one or more charging device, etc.). In addition, the capacity data 622 can include current use data indicative a current power usage of the aerial transport facility. The current use data, for example, can be determined based on the power usage data associated with each of the plurality of climate control devices of the climate control infrastructure. In some implementations, the capacity data 622 can include an available capacity indicative of a power level (e.g., a wattage) available for charging and/or cooling operations. The available capacity data can include currently available capacity data indicative of the available capacity at a current time and/or one or more future available capacities indicative an available capacity at one or more future times. For example, the currently available capacity data can be determined based on the overall energy capacity and/or the current use data (e.g., by subtracting the current use data from the total power capacity).

The computing system 605 can determine a climate control configuration 655 for the climate control infrastructure at the aerial transport facility for at least the first aerial vehicle that is located and/or scheduled to be located at the aerial transport facility. The climate control configuration 655 can include an assignment of one or more climate control devices to service the first aerial vehicle, a time to service the first aerial vehicle, one or more cooling operations to implement for the first aerial vehicle, and/or any other information for managing climate control for the first aerial vehicle. For instance, the climate control configuration 655 can identify at least a portion of the climate control infrastructure at the aerial transport facility for cooling hardware of the aerial vehicle, a cabin of the aerial vehicle, and/or a power system of the aerial vehicle.

The computing system 605 can determine the climate control configuration 655 based on the data associated with the multi-modal transportation service (e.g., itinerary data 610), the one or more thermal parameters 636 of the first aerial vehicle, the facility data 620 associated with the aerial transport facility, one or more desired conditions 640, charging resources 645, environment data 650, and/or any other data associated with maintaining the climate of one or more components of the first aerial vehicle. For example, the climate control configuration 655 can identify a climate control device to service (e.g., cool) one or more components (e.g., the hardware, cabin, power system, etc.) of the first aerial vehicle based on device data 460 associated with each of the plurality of climate control devices and/or vehicle data 635 associated with the first vehicle.

For instance, the climate control configuration 655 can include an assignment of the climate control device to the first aerial vehicle (and/or one or more components of the aerial vehicle). In some implementations, the computing system 605 can identify the climate control device based on the device data 460 associated with each of the climate control devices of the climate control infrastructure at the aerial transport facility and/or the vehicle data 635 associated with at least the first aerial vehicle. For example, the computing system 605 can assign the climate control device to service the first aerial vehicle based on the respective location of the aerial vehicle and/or the climate control device, the thermal parameters 636 of the aerial vehicle and/or the cooling supply of the climate control device, the vehicle layout 638 of the aerial vehicle and/or the device type of the climate control device, the first flight itinerary 615 of the aerial vehicle and/or the assignment data of the climate control device, and/or any other climate control related factors.

By way of example, the computing system 605 can identify the climate control device by determining that the climate control device is within a proximity to the aerial vehicle (e.g., based on the vehicle location and the device location), the climate control device has a threshold level of cooling material to service the aerial vehicle (e.g., based on the thermal parameters 636 of the aerial vehicle and the cooling supply of the climate control device), the climate control device can interface with one or more components of the aerial vehicle (e.g., based on the vehicle layout 638 of the aerial vehicle and the device type of the climate control device), and/or that the climate control device is available to service the first aerial vehicle (e.g., based on the first flight itinerary 615 of the aerial vehicle and/or the assignment data of the climate control device). In this manner, the computing system 605 can assign a climate control device to service at least one component of the first aerial vehicle such that the climate control device is capable and/or available to perform one or more climate control operations for the at least one component of the first aerial vehicle.

More specifically, the climate control configuration 655 can include one or more climate control parameters such as, for example, a climate control time period, a climate control location, one or more desired thermal conditions 640 (e.g., a desired thermal condition for each component (e.g., cabin, power system, hardware, etc.) of the first aerial vehicle), and/or an energy allocation. For example, determining the climate control configuration 655 can include determining one or more desired thermal conditions 640. A respective desired thermal condition 640 for the aerial vehicle can include a desired temperature for a respective component of the first aerial vehicle to reach before departing from the aerial transport facility.

In some implementations, the computing system 605 can monitor, via one or more thermal sensors of the first aerial vehicle, the one or more thermal parameters 636 of the first aerial vehicle. In such a case, the computing system 605 can detect that at least one of the thermal parameter(s) 636 has achieved, is estimated to achieve, and/or is within a range of a respective threshold temperature for a corresponding component of the first aerial vehicle. In some implementations, the computing system 605 can determine the climate control configuration 655 for the climate control infrastructure at the aerial transport facility for the first aerial vehicle in response to detecting that the at least of the one of the one or more thermal parameters 636 has achieved at least one of the one or more threshold temperatures.

The computing system 605 can determine the one or more desired thermal conditions 640 for the first aerial vehicle to reach before departing from the aerial transport facility based on one or more climate control factors. The one or more desired thermal conditions 640, for example, can be based on the first flight itinerary 615 (e.g., a parking time at the aerial transport facility, an upcoming flight, etc.), the thermal parameter(s) 636 of the first aerial vehicle, and/or the threshold temperatures associated with each component of the first aerial vehicle. By way of example, each of the one or more desired thermal conditions 640 can be indicative of a desired temperature for at least one component of the first aerial vehicle. The desired temperature can include a temperature below a respective threshold temperature associated with each component of the first aerial vehicle. The computing system 605 can determine a desired thermal condition 640 by comparing a thermal parameter 636 associated with a respective component of the first aerial vehicle to a threshold temperature associated with the respective component. Achieving the desired thermal condition 640 can include lowering the temperature (e.g., as indicated by the thermal parameter 636) of the respective component below the threshold temperature.

The one or more desired thermal conditions 640, for example, can be based on one or more aspects of the first flight itinerary 615. For instance, the desired thermal conditions 640 can be based on one or more upcoming flights for the aerial vehicle after departing the aerial transport facility. For instance, the desired thermal condition 640 for a respective component can include a temperature below a respective threshold temperature for the respective component such that a respective component does not reach the respective threshold temperature during an upcoming flight. For example, a component (cabin, hardware, power system, etc.) of the aerial vehicle can retain heat during a flight. In such a case, the computing system 605 can determine an estimated temperature increase for each component of the aerial vehicle based on the time and/or one or more other aspects (e.g., payload, number of passengers, type of cargo, etc.) of the upcoming flight. Accordingly, the one or more desired thermal conditions 640 can be determined based on the estimated time and/or the one or more other aspects (e.g., payload, number of passengers, type of cargo, etc.) of the upcoming flight. For instance, the one or more desired thermal conditions 640 can be determined based on the estimated temperature increase during the upcoming flight. Additionally, or alternatively, the desired thermal conditions 640 (and/or climate control configuration 655) can be based on the layout 638 of a vehicle. For example, a vehicle may have an onboard thermal management system that cools the vehicle's cabin by transferring heat to the vehicle's power source (e.g., batteries, etc.). In some implementations, the more passengers onboard the vehicle can result in more heat being transferred from the cabin to the vehicle's power source to maintain the desired temperature of the cabin. The thermal conditions 640 (and/or the climate configuration 655) associated with the vehicle's power source can be determined based on the number of passengers that have been transported and/or are to be transported in the vehicle as indicated by an itinerary and/or other data. For example, certain cooling infrastructure can be chosen to reduce the power source to a certain temperature knowing that a certain level of heat has been or will be transferred to the power source given the number of passengers that rode, are riding, or will ride in the vehicle.

The climate control location can be indicative of an assigned location to service the first aerial vehicle. The assigned location, for example, can include a parking location, charging location, cooling location, etc. of the landing area of the aerial transport facility. In some implementations, the assigned location can be determined based on the assigned climate control device. By way of example, the assigned location can include a parking location, charging location, cooling location, etc. of the landing area where a stationary climate control device assigned to service the aerial vehicle is located. In addition, or alternatively, the assigned location can be a scheduled location based on the landing area and/or state (e.g., occupied, available, etc.) of one or more locations (e.g., parking, cooling, charging, etc.) of the landing area. In some implementations, the climate control device can be assigned to service the first aerial vehicle based on the assigned location. For instance, the climate control device can include a stationary climate control device located at the assigned location and/or a mobile climate control device within a proximity to the assigned location.

The climate control time period can be indicative of an estimated time to achieve the one or more desired thermal conditions 640 of the climate control configuration 655. The climate control energy allocation can be indicative of an estimate power level (e.g., wattage) to achieve the one or more desired thermal conditions 640 of the climate control configuration 655. For example, the computing system 605 can determine a climate control energy allocation for at least the first aerial vehicle. The climate control energy allocation can be indicative of an amount of energy sufficient to achieve a desired thermal condition 640 for the aerial vehicle. In some implementations, the climate control energy allocation can correspond to the climate control time period. For instance, the energy allocation can include a power level (e.g., wattage) over time. In some implementations, the energy allocation can increase as the climate control time period decreases. For instance, the energy allocation can include a total energy expense for achieving the one or more desired thermal conditions 640. The total energy expense can be spread out over the climate control time period such that a longer climate control time period can result in a lower energy allocation over time and a shorter climate control time period can result in a higher energy allocation over time.

In some implementations, the computing system 605 can determine the climate control configuration 655 (e.g., a climate control time period, energy allocation, etc.) for the climate control infrastructure based on one or more charging parameters 637 associated with the first aerial vehicle and/or the one or more second aerial vehicles. For instance, the computing system 605 can determine charging parameters 637 for the first aerial vehicle and/or the one or more second aerial vehicles based at least in part on the vehicle data 635. The charging parameters 637, for example, can include a current charge level for a power system of the aerial vehicle. The computing system 605 can determine charging resources 645 for the first aerial vehicle and/or the one or more second aerial vehicles at the aerial transport facility based at least in part the charging parameters 637. For instance, the charging resources 645 can include charging energy allocations for each of the first and second aerial vehicles. A respective charging energy allocation can be indicative of an amount of energy sufficient to charge an associated aerial vehicle, for example, to complete an upcoming flight.

The computing system 605 can determine the climate control configuration 655 for the climate control infrastructure at the aerial transport facility for a first aerial vehicle based at least in part on the charging resources 645. For instance, the computing system 605 can determine an overall energy allocation at the aerial transport facility based on the charging energy allocation for each of the first and second aerial vehicles and the climate control energy allocation for the first aerial vehicle and/or the one or more second aerial vehicles. The overall energy allocation can be indicative of an allocation of energy for facilitating the charging of each of the first and second aerial vehicles and an allocation of energy for facilitating the climate control configuration 655 for the first aerial vehicle and/or second aerial vehicles. The overall energy allocation, for example, can include an allocation of energy over time. The computing system 605 can determine the climate control energy allocation such that the overall energy allocation does not exceed the overall energy capacity 622 of the aerial transport facility at any given time.

In addition, or alternatively, the computing system 605 can determine the climate control configuration 655 based at least in part on the estimated time period for which the first aerial vehicle will be located at the aerial transport facility. For example, the computing system 605 can determine the climate control configuration 655 for the first aerial vehicle to reach a desired thermal condition 640 within the estimated time period. By way of example, the computing system 605 can determine the climate control time period such that climate control time period is within the estimated time period. In this manner, the climate control configuration 655 can include a climate control energy allocation that depends on the estimated time period. For instance, the computing system 605 can determine a higher climate control energy allocation over time for shorter estimated time periods and a lower climate control energy allocation over time for longer estimated time periods.

In some implementations, the computing system 605 can determine the climate control configuration 655 for the climate control infrastructure at the aerial transport facility for the first aerial vehicle based on environmental data 650. For instance, the computing system 605 can obtain environmental data 650 indicative of one or more thermal environmental factors (e.g., outside temperature, wind chill, humidity, weather, etc.) associated with an operating environment of the first vehicle. The computing system 605 determine one or more aspects of the climate control configuration 655 based on the one or more thermal environmental factors. For instance, the climate control energy allocation can be determined based the one or more thermal environmental factors. By way of example, a higher climate control energy allocation can be determined in the event that the outside temperature is higher than a desired thermal condition 640. Moreover, a lower climate control energy allocation can be determined in the event that wind chill and/or rain lowers the outside temperate below a desired thermal condition 640.

In addition, or alternatively, the climate control configuration 655 can include one or more climate control processes. The climate control processes can identify a method of achieving a desired thermal condition 640 for a component of an aerial vehicle. By way of example, a climate control process can specify a respective climate control interface for implementing a climate control operation (e.g., a cooling fan to cool a cabin of an aerial vehicle, a cooling rod to cool a power source of a vehicle, etc.). In some implementations, a climate control process can depend on the one or more environmental factors. For instance, the effectiveness of a climate control interface can depend on the one or more environmental factors. By way of example, a climate control interface such as a cooling fan configured to blow cool air over cold water can be more effective in drier climates and less effective in humid environments. In such a case, the computing system 605 can determine climate control device based on an estimated effectiveness of one or more climate control interfaces of the climate control device in the operating environment of the aerial vehicle.

In this manner, the computing system 605 can determine a climate control configuration 655 to service one or more aerial vehicles at the aerial transport facility. As discussed herein, the climate control configuration 655 can include an assignment of at least one climate control device of a climate control infrastructure to service a first aerial vehicle. By way of example, the assignment can include a reservation and an energy allocation for a stationary climate control device and/or a reservation, an energy allocation, and/or a cooling location for a mobile climate control device.

The computing system 605 can generate one or more command signals associated with controlling the climate control infrastructure at the aerial transport facility. The command signals, for example, can be indicative of the climate control configuration 655. For example, the command signals can include an indication of one or more components of the first aerial vehicle to be serviced, an interface for servicing the one or more components, etc. The climate control device(s) can implement the climate control configuration 655, via the one or more climate control interfaces, in response to the command signals.

For instance, the computing system 605 can include a cloud computing system (e.g., cloud computing system 102 of FIG. 1). In such a case the cloud computing system can communicate the one or more command signals associated with controlling the climate control infrastructure to at the aerial transport facility. As an example, the computing system can communicate the one or more command signals to an aerial transport facility computing system (e.g., facility computing device(s) 152 of FIG. 1). The aerial transport facility computing system can receive the instructions and control one or more portions of the climate control infrastructure (e.g., the central climate control system, one or more climate control devices, etc.) to implement the climate control configuration 655 in response to the instructions.

As another example, the computing system 605 can include an aerial facility computing system (e.g., facility computing device(s) 152 of FIG. 1). In such a case, the aerial facility computing system can communicate the one or more command signals to the climate control infrastructure (e.g., a computing system of the central climate control system, one or climate control devices, etc.). In addition, or alternatively, the computing system can include a third party system and/or a vehicle computing system onboard the aerial vehicle (e.g., aerial computing device(s) 142 of FIG. 1). The third party system and/or the vehicle computing system can communicate the one or more command signals to the cloud computing system, the facility computing system, and/or directly to the climate control infrastructure (e.g., a computing system of a central climate control system, one or more of the plurality of climate control devices, etc.).

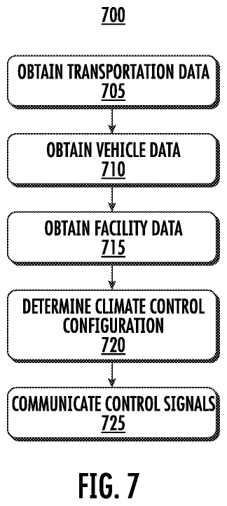

Turning to FIG. 7, FIG. 7 depicts a flowchart of a method 700 for facilitating climate control for aerial vehicles according to aspects of the present disclosure. One or more portion(s) of the method 700 can be implemented by a computing system that includes one or more computing devices such as, for example, the computing systems described with reference to the other figures (e.g., the cloud services system 102, facility computing device(s) 152, aerial computing device(s) 142, a climate control infrastructure 192, vehicle provider computing device(s) 195, etc.). Each respective portion of the method 700 can be performed by any (or any combination) of one or more computing devices. Moreover, one or more portion(s) of the method 700 can be implemented as an algorithm on the hardware components of the device(s) described herein (e.g., as in FIGS. 1, 4, 5, 9, etc.), for example, to facilitate climate control for aerial vehicles. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for exemplary illustrated purposes and is not meant to be limiting. One or more portions of method 700 can be performed additionally, or alternatively, by other systems.

At 705, the method 700 can include obtaining transportation data. For example, a computing system (e.g., system 100, computing system 605, etc.) can obtain data associated with a multi-modal transportation service. The data associated with the multi-modal transportation service can include itinerary data indicative of one or more flight itineraries for one or more aerial vehicles. The one or more aerial vehicles can include a first aerial vehicle. For example, the itinerary data can be indicative of an estimated time period for which the first aerial vehicle will be located at the aerial transport facility.

At 710, the method 700 can include obtaining vehicle data. For example, a computing system (e.g., system 100, computing system 605, etc.) can obtain vehicle data associated with the one or more aerial vehicles. The vehicle data can be indicative of one or more thermal parameters of the one or more aerial vehicles. The one or more thermal parameters of the first aerial vehicle can include at least one of a battery cooling parameter, a cabin cooling parameter, or a hardware cooling parameter. For example, the first aerial vehicle can include a plurality of thermal sensors configured to identify the one or more thermal parameters of the first aerial vehicle.

In some implementations, the computing system can monitor, via the one or more thermal sensors, the one or more thermal parameters of the first aerial vehicle. In such a case, the computing system can determine a climate control configuration for the climate control infrastructure at an aerial transport facility for the first aerial vehicle in response to detecting that at least one of the one or more thermal parameters has achieved one or more threshold temperatures. The one or more threshold temperatures can include a different threshold for one or more components of the first aerial vehicle.

At 715, the method 700 can include obtaining facility data. For example, a computing system (e.g., system 100, computing system 605, etc.) can obtain facility data associated with an aerial transport facility for providing the multi-modal transportation service. The facility data can be indicative of a climate control infrastructure at the aerial transport facility. The climate control infrastructure can include one or more stationary climate control devices and/or mobile climate control devices.

The one or more of the aerial vehicles can utilize the aerial transport facility, for example, to provide a transportation service. For example, the facility data can be indicative of one or more second aerial vehicles that are scheduled to be located at the aerial transport facility at a concurrent time period as the first aerial vehicle.

At 720, the method 700 can include determining a climate control configuration. For example, a computing system (e.g., system 100, computing system 605, etc.) can determine a climate control configuration for the climate control infrastructure at the aerial transport facility for a first aerial vehicle based at least in part on the data associated with the multi-modal transportation service, one or more thermal parameters of the first aerial vehicle, and the facility data associated with the aerial transport facility. The climate control configuration can identify at least one of: a stationary climate control device or a mobile climate control device to cool at least a portion of the first aerial vehicle. For example, the climate control configuration can identify at least a portion of the climate control infrastructure at the aerial transport facility for cooling hardware of the aerial vehicle. In addition, the climate control configuration can identify at least a portion of the climate control infrastructure at the aerial transport facility for cooling a cabin of the aerial vehicle. Moreover, in some implementations, the climate control configuration can identify at least a portion of the climate control infrastructure at the aerial transport facility for cooling a power system of the aerial vehicle.

Determining the climate control configuration for the climate control infrastructure at the aerial transport facility for the first aerial vehicle can include determining the climate control configuration based at least in part on the estimated time period for which the first aerial vehicle will be located at the aerial transport facility. For example, the computing system can determine the climate control configuration for the aerial vehicle to reach a desired thermal condition within the estimated time period.

At 725, the method 700 can include communicating control signals. For example, a computing system (e.g., system 100, computing system 605, etc.) can communicate one or more command signals associated with controlling the climate control infrastructure at the aerial transport facility. The command signals can be indicative of the climate control configuration. For example, the climate control infrastructure can include one or more climate control devices. The one or more climate control devices can be configured to implement the climate control configuration.

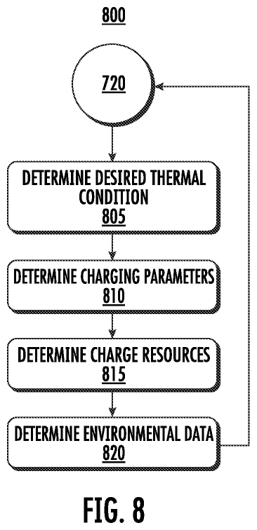

Turning to FIG. 8, FIG. 8 is a flowchart of a method 800 for determining a climate control configuration according to aspects of the present disclosure. One or more portion(s) of the method 800 can be implemented by a computing system that includes one or more computing devices such as, for example, the computing systems described with reference to the other figures (e.g., the cloud services system 102, facility computing device(s) 152, aerial computing device(s) 142, a climate control infrastructure 192, vehicle provider computing device(s) 195, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIGS. 1, 4, 5, 9, etc.), for example, to determine a climate control configuration. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for exemplary illustrated purposes and is not meant to be limiting. One or more portions of method 800 can be performed additionally, or alternatively, by other systems.

Method 800, for example, can being at step 720 of method 700 where method 700 is configured to determine a climate control configuration. To determine a climate control configuration, at 720, the method 800 can include determining a desired thermal condition at 805. For example, a computing system (e.g., system 100, computing system 605, etc.) can determine a desired thermal condition for the first aerial vehicle to reach before departing from the aerial transport facility.

At 810, the method 800 can include determining charging parameters. For example, a computing system (e.g., system 100, computing system 605, etc.) can determine charging parameters for the first aerial vehicle and one or more second vehicles based at least in part on the vehicle data.

At 815, the method 800 can include determining charging resources. For example, a computing system (e.g., system 100, computing system 605, etc.) can determine charging resources for the first aerial vehicle and the one or more second aerial vehicles at the aerial transport facility based at least in part the charging parameters. The charging resources, for example, can include charging energy allocations for each of the first and second aerial vehicles. For instance, a respective charging energy allocation can be indicative of an amount of energy needed to charge an associated aerial vehicle.

The computing system can determine the climate control configuration for the climate control infrastructure at the aerial transport facility for a first aerial vehicle based at least in part on the charging resources. For example, the computing system can determine a climate control energy allocation for at least the first aerial vehicle. The climate control energy allocation can be indicative of an amount of energy needed to reach a desired thermal condition for the aerial vehicle. In addition, the computing system can determine an overall energy allocation at the aerial transport facility based on the charging energy allocation for each of the first and second aerial vehicles and the climate control energy allocation for at least the first aerial vehicle. The overall energy allocation can be indicative of an allocation of energy for facilitating the charging of each of the first and second aerial vehicles and an allocation of energy for facilitating the climate control configuration for the first aerial vehicle.

For example, the climate control configuration can be indicative of at least one of: a reservation and an energy allocation for the stationary climate control device or a reservation, an energy allocation, or a cooling location for the mobile climate control device. For example, the stationary climate control device can be configured to facilitate a cooling of the first aerial vehicle based at least in part on the reservation and the energy allocation for the stationary climate control device. In addition, or alternatively, the mobile climate control device can be configured to travel to the cooling location and facilitate the cooling of the first aerial vehicle based at least in part on the reservation and the energy allocation for the mobile climate control device.

At 820, the method 800 can include determining environmental data. For example, a computing system (e.g., system 100, computing system 605, etc.) can obtain environmental data indicative of thermal environmental factors associated with an operating environment of the first aerial vehicle. The computing system can determine the climate control configuration for the climate control infrastructure at the aerial transport facility for the first aerial vehicle based at least in part on the environmental data. For example, a higher outdoor temperature may result in more cooling efforts, while a lower outdoor temperature may result in a lower cooling effort and/or possible heating (e.g., of a cabin, etc.).

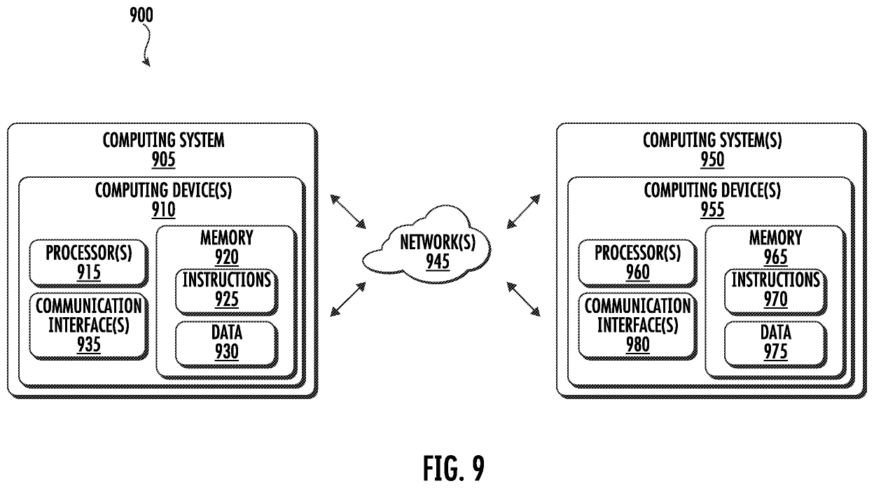

FIG. 9 depicts example system components of an example system 900 according to example embodiments of the present disclosure. The example system 900 can include the computing system 905 (e.g., a cloud services system 102) and the computing system(s) 950 (e.g., rider device(s) 140, aerial computing device(s) 142, service provider computing device(s) 150, 160, 170, facility computing device(s) 152, climate control infrastructure 192, etc.), etc. that are communicatively coupled over one or more network(s) 945.

The computing system 905 can include one or more computing device(s) 910. The computing device(s) 910 of the computing system 905 can include processor(s) 915 and a memory 920. The one or more processors 915 can be any suitable processing device (e.g., a processor core, a microprocessor, an ASIC, a FPGA, a controller, a microcontroller, etc.) and can be one processor or a plurality of processors that are operatively connected. The memory 920 can include one or more non-transitory computer-readable storage media, such as RAM, ROM, EEPROM, EPROM, one or more memory devices, flash memory devices, etc., and combinations thereof.

The memory 920 can store information that can be accessed by the one or more processors 915. For instance, the memory 920 (e.g., one or more non-transitory computer-readable storage mediums, memory devices) can include computer-readable instructions 925 that can be executed by the one or more processors 915. The instructions 925 can be software written in any suitable programming language or can be implemented in hardware. Additionally, or alternatively, the instructions 925 can be executed in logically and/or virtually separate threads on processor(s) 915.

For example, the memory 920 can store instructions 925 that when executed by the one or more processors 915 cause the one or more processors 915 to perform operations such as any of the operations and functions for which the computing systems (e.g., cloud services system) are configured, as described herein.

The memory 920 can store data 930 that can be obtained, received, accessed, written, manipulated, created, and/or stored. The data 930 can include, for instance, facility data, vehicle data, itinerary data, climate control data, and/or other data/information described herein. In some implementations, the computing device(s) 910 can obtain from and/or store data in one or more memory device(s) that are remote from the computing system 905 such as one or more memory devices of the computing system 950.

The computing device(s) 910 can also include a communication interface 935 used to communicate with one or more other system(s) (e.g., computing system 950). The communication interface 935 can include any circuits, components, software, etc. for communicating via one or more networks (e.g., 945). In some implementations, the communication interface 935 can include for example, one or more of a communications controller, receiver, transceiver, transmitter, port, conductors, software and/or hardware for communicating data/information.

The computing system 950 can include one or more computing devices 955. The one or more computing devices 955 can include one or more processors 960 and a memory 965. The one or more processors 960 can be any suitable processing device (e.g., a processor core, a microprocessor, an ASIC, a FPGA, a controller, a microcontroller, etc.) and can be one processor or a plurality of processors that are operatively connected. The memory 965 can include one or more non-transitory computer-readable storage media, such as RAM, ROM, EEPROM, EPROM, one or more memory devices, flash memory devices, etc., and combinations thereof.

The memory 965 can store information that can be accessed by the one or more processors 960. For instance, the memory 965 (e.g., one or more non-transitory computer-readable storage mediums, memory devices) can store data 975 that can be obtained, received, accessed, written, manipulated, created, and/or stored. The data 975 can include, for instance, facility data, vehicle data, itinerary data, climate control data, and/or other data or information described herein. In some implementations, the computing system 950 can obtain data from one or more memory device(s) that are remote from the computing system 950.

The memory 965 can also store computer-readable instructions 970 that can be executed by the one or more processors 960. The instructions 970 can be software written in any suitable programming language or can be implemented in hardware. Additionally, or alternatively, the instructions 970 can be executed in logically and/or virtually separate threads on processor(s) 960. For example, the memory 965 can store instructions 970 that when executed by the one or more processors 960 cause the one or more processors 960 to perform any of the operations and/or functions described herein, including, for example, any of the operations and functions of the devices described herein, and/or other operations and functions.

The computing device(s) 955 can also include a communication interface 980 used to communicate with one or more other system(s). The communication interface 980 can include any circuits, components, software, etc. for communicating via one or more networks (e.g., 945). In some implementations, the communication interface 980 can include for example, one or more of a communications controller, receiver, transceiver, transmitter, port, conductors, software and/or hardware for communicating data/information.

The network(s) 945 can be any type of network or combination of networks that allows for communication between devices. In some embodiments, the network(s) 945 can include one or more of a local area network, wide area network, the Internet, secure network, cellular network, mesh network, peer-to-peer communication link and/or some combination thereof and can include any number of wired or wireless links. Communication over the network(s) 945 can be accomplished, for instance, via a network interface using any type of protocol, protection scheme, encoding, format, packaging, etc.

FIG. 9 illustrates one example system 900 that can be used to implement the present disclosure. Other computing systems can be used as well. Computing tasks discussed herein as being performed at a cloud services system can instead be performed remote from the cloud services system (e.g., via aerial computing devices, robotic computing devices, facility computing devices, etc.), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system for aerial vehicle climate control, comprising:
one or more processors; and
one or more memory resources storing instructions that, when executed by the one or more processors, cause the computing system to:
obtain data associated with a multi-modal transportation service, wherein the data associated with the multi-modal transportation service comprises itinerary data indicative of one or more flight itineraries for one or more aerial vehicles;
obtain vehicle data associated with the one or more aerial vehicles, wherein the vehicle data is indicative of one or more thermal parameters of the one or more aerial vehicles;
obtain facility data associated with an aerial transport facility for providing the multi-modal transportation service, wherein the facility data is indicative of a climate control infrastructure at the aerial transport facility, wherein one or more of the aerial vehicles are to utilize the aerial transport facility;
determine a climate control configuration for the climate control infrastructure at the aerial transport facility for a first aerial vehicle based at least in part on the data associated with the multi-modal transportation service, one or more thermal parameters of the first aerial vehicle, and the facility data associated with the aerial transport facility; and
communicate one or more command signals associated with controlling the climate control infrastructure at the aerial transport facility, wherein the command signals are indicative of the climate control configuration.

2. The computing system of claim 1, wherein determining the climate control configuration for the climate control infrastructure at the aerial transport facility for the first aerial vehicle comprises:
determining a desired thermal condition for the first aerial vehicle.

3. The computing system of claim 1, wherein the facility data is indicative of one or more second aerial vehicles that are scheduled to be located at the aerial transport facility at a concurrent time period as the first aerial vehicle, and wherein the operations further comprise:
determining charging parameters for the first aerial vehicle and the one or more second vehicles based at least in part on the vehicle data;
determining charging resources for the first aerial vehicle and the one or more second aerial vehicles at the aerial transport facility based at least in part the charging parameters; and
determining the climate control configuration for the climate control infrastructure at the aerial transport facility for a first aerial vehicle based at least in part on the charging resources.

4. The computing system of claim 3, wherein the charging resources comprise charging energy allocations for each of the first and second aerial vehicles, wherein a respective charging energy allocation is indicative of an amount of energy needed to charge an associated aerial vehicle.

5. The computing system of claim 4, wherein determining the climate control configuration for the climate control infrastructure at the aerial transport facility for the first aerial vehicle based at least in part on the charging resources comprises:
determining a climate control energy allocation for at least the first aerial vehicle, wherein the climate control energy allocation is indicative of an amount of energy needed to reach a desired thermal condition for the aerial vehicle; and
determining an overall energy allocation at the aerial transport facility based on the charging energy allocation for each of the first and second aerial vehicles and the climate control energy allocation for at least the first aerial vehicle,
wherein the overall energy allocation is indicative of an allocation of energy for facilitating the charging of each of the first and second aerial vehicles and an allocation of energy for facilitating the climate control configuration for the first aerial vehicle.

6. The computing system of claim 1, wherein the itinerary data is indicative of an estimated time period for which the first aerial vehicle will be located at the aerial transport facility, and wherein determining the climate control configuration for the climate control infrastructure at the aerial transport facility for the first aerial vehicle comprises:
determining the climate control configuration based at least in part on the estimated time period for which the first aerial vehicle will be located at the aerial transport facility.

7. The computing system of claim 6, wherein determining the climate control configuration based at least in part on the estimated time period for which the first aerial vehicle will be located at the aerial transport facility comprises:
determining the climate control configuration for the aerial vehicle to reach a desired thermal condition within the estimated time period.

8. The computing system of claim 1, wherein the climate control infrastructure comprises one or more stationary climate control devices or mobile climate control devices; and
wherein the climate control configuration identifies at least one of: a stationary climate control device or a mobile climate control device to cool at least a portion of the first aerial vehicle.

9. The computing system of claim 8, wherein the climate control configuration is indicative of at least one of: a reservation and an energy allocation for the stationary climate control device or a reservation, an energy allocation, or a cooling location for the mobile climate control device,
wherein the stationary climate control device is configured to facilitate a cooling of the first aerial vehicle based at least in part on the reservation and the energy allocation for the stationary climate control device, and
wherein the mobile climate control device is configured to travel to the cooling location and facilitate the cooling of the first aerial vehicle based at least in part on the reservation and the energy allocation for the mobile climate control device.

10. The computing system of claim 1, wherein the climate control configuration identifies at least a portion of the climate control infrastructure at the aerial transport facility for cooling hardware of the aerial vehicle.

11. The computing system of claim 1, wherein the climate control configuration identifies at least a portion of the climate control infrastructure at the aerial transport facility for cooling a cabin of the aerial vehicle.

12. The computing system of claim 1, wherein the climate control configuration identifies at least a portion of the climate control infrastructure at the aerial transport facility for cooling a power system of the aerial vehicle.

13. The computing system of claim 1, wherein the operations further comprise:
obtaining environmental data indicative of thermal environmental factors associated with an operating environment of the first aerial vehicle, and
wherein determining the climate control configuration for the climate control infrastructure at the aerial transport facility for the first aerial vehicle comprises determining the climate control configuration based at least in part on the environmental data.

14. A computer-implemented method for aerial vehicle climate control, the method comprising:
obtaining, by a computing system comprising one or more computing devices, data associated with a multi-modal transportation service, wherein the data associated with the multi-modal transportation service comprises itinerary data indicative of one or more itineraries of one or more aerial vehicles for facilitating one or more multi-modal transportation services;
obtaining, by the computing system, vehicle data associated with the one or more aerial vehicles, wherein the vehicle data is indicative of one or more thermal parameters of the one or more aerial vehicles;
obtaining, by the computing system, facility data associated with an aerial transport facility for providing the multi-modal transportation service, wherein the facility data is indicative of a climate control infrastructure at the aerial transport facility, wherein at least one of the one or more aerial vehicles are to utilize the aerial transport facility;
determining, by the computing system, a climate control configuration for the climate control infrastructure at the aerial transport facility for a first aerial vehicle based at least in part on the data associated with the multi-modal transportation service, one or more thermal parameters of the first aerial vehicle, and the facility data associated with the aerial transport facility; and
communicating, by the computing system, one or more command signals associated with controlling the climate control infrastructure at the aerial transport facility, wherein the command signals are indicative of the climate control configuration.

15. The computer-implemented method of claim 14, wherein the one or more thermal parameters of the first aerial vehicle comprise at least one of a battery cooling parameter, a cabin cooling parameter, or a hardware cooling parameter.

16. The computer-implemented method of claim 14, wherein the first aerial vehicle comprises a plurality of thermal sensors configured to identify the one or more thermal parameters of the first aerial vehicle.

17. The computer-implemented method of claim 16, wherein the method further comprises:
monitoring, by the computing system via the one or more thermal sensors, the one or more thermal parameters of the first aerial vehicle; and
determining, by the computing system, the climate control configuration for the climate control infrastructure at the aerial transport facility for the first aerial vehicle in response to detecting that at least one of the one or more thermal parameters has achieved one or more threshold temperatures.

18. The computer-implemented method of claim 17, wherein the one or more threshold temperatures comprises a different threshold for one or more components of the first aerial vehicle.

19. A computing system comprising:
a climate control infrastructure;
one or more processors; and
one or more memory resources storing instructions that, when executed by the one or more processors, cause the computing system to:
obtain data associated with a multi-modal transportation service, wherein the data associated with the multi-modal transportation service comprises itinerary data indicative of one or more itineraries of one or more aerial vehicles for facilitating one or more multi-modal transportation services;
obtain vehicle data associated with the one or more aerial vehicles, wherein the vehicle data is indicative of one or more thermal parameters of the one or more aerial vehicles;
obtain facility data associated with an aerial transport facility for providing the multi-modal transportation service, wherein the facility data is indicative of the climate control infrastructure, wherein one or more of the aerial vehicles are to utilize the aerial transport facility;
determine a climate control configuration for the climate control infrastructure at the aerial transport facility for a first aerial vehicle based at least in part on the data associated with the multi-modal transportation service, one or more thermal parameters of the first aerial vehicle, and the facility data associated with the aerial transport facility; and
communicate one or more command signals associated with controlling the climate control infrastructure at the aerial transport facility to the climate control infrastructure, wherein the command signals are indicative of the climate control configuration.

20. The computing system of claim 19, wherein the climate control infrastructure comprises one or more climate control devices; and
wherein the one or more climate control devices comprise one or more climate control interfaces configured to implement the climate control configuration.
